(19) United States
(12) Patent Application Publication
(10) Pub. No.: US 2005/0189410 A1
(43) Pub. Date: Sep. 1, 2005

(54) System and method for calculating applicable recording charges for a transaction

(76) Inventors: Lorraine O'Reilly Brown, Alpharetta, GA (US); Gregory Alan Brown, Alpharetta, GA (US); Ronald Meharg, Alpharetta, GA (US); Jimmy Nye, Alpharetta, GA (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/088,671

(22) Filed: Mar. 23, 2005

Related U.S. Application Data
(60) Provisional application No. 60/555,098, filed on Mar. 23, 2004.

(51) Int. Cl. G06F 17/60

(52) U.S. Cl. 235/379; 705/19; 705/38

(57) ABSTRACT

The present invention provides a method for providing calculating applicable recording charges for a transaction. The system includes means for determining which recording office is appropriate for recording the transaction, and means for determining a type of the transaction. In addition, the system includes means for calculating at least one charge required for recording the transaction, and means for displaying total charges for recording the transaction. The present invention can also be viewed as a method for providing calculating applicable recording charges for a transaction. The method operates by determining which recording office is appropriate for recording the transaction and then determining a type of the transaction. Then, the method calculates at least one charge required for recording the transaction; and displays total charges for recording the transaction.

### CROSS-REFERENCE TO RELATED APPLICATIONS

This application claims the benefit of U.S. Provisional Patent Application Ser. No. 60/555,098, filed on Mar. 23, 2004, entitled “FEEWISE”, which is incorporated by reference herein in its entirety.

### COPYRIGHT NOTICE

A portion of the disclosure of this patent document may contain material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates to a method and system for calculating applicable recording charges for a transaction, and more particularly, relates to a method and system for calculating applicable fees for transactions related to real property, personal property, liens, licenses, certificates, permits and the like.

### BACKGROUND OF THE INVENTION

Currently in the United States, we have a financial system that allows lenders to operate in and over 3700 recording offices in the United States alone. There were 17 million mortgages (i.e. first lien) originated in the United States in 2004. In processing these at least 17 million mortgages each and every lender had to comply with strict federal rules that govern disclosure of various fees and taxes within three days of application, on a good-faith estimate, according to the Real Estate Settlement Procedures Act 2002 (RESPA). Other applicable statutes include the truth in lending act (i.e. TILA) and many HUD regulations. This is in addition to numerous applicable state statutes.

In addition to the disclosure requirements, there is a requirement to accurately collect the appropriate fees for payment. Upon determining the appropriate fees for payment for each transaction, then the disbursement actually needs to be made. These fees are listed on every in every closing transaction in a HUD1. The problem is if there is any shortage in the fees and taxes collected from the mortgagor, that the amount short must be covered by the lender. The reverse situation creates a bigger problem in that if the lender collects more fees than are necessary, that lender has committed an unlawful act.

The problem for the lenders is that there are 3700 plus different recording offices and 31 different loan transaction types. In addition to these two statistics, there are 33 different types of fees that may be collected depending upon the recording jurisdiction, and rarely do these jurisdictions overlap with the same recording fees and taxes.

Currently, most lenders calculate the fees based upon estimates previously processed transactions or must maintain a skilled staff to interpret tax code and fee structures for each recording office jurisdiction. The problem with the skilled staff is that they can make the human errors that can be extremely costly for the lender.

Therefore, there is a tremendous need for an automated system to accurately determine, document, and process these fees and taxes.

### SUMMARY OF THE INVENTION

The present invention provides for calculating applicable recording charges for a transaction, and more particularly, relates to a method and system for calculating applicable fees for transactions related to real property, personal property, liens, licenses, certificates, permits and the like.

The system includes means for determining which recording office is appropriate for recording the transaction, and means for determining a type of the transaction. In addition, the system includes means for calculating at least one charge required for recording the transaction, and means for displaying total charges for recording the transaction.

The present invention can be viewed as a method for providing calculating applicable recording charges for a transaction. The method operates by (1) determining which recording office is appropriate for recording the transaction; (2) determining a type of the transaction; (3) calculating at least one charge required for recording the transaction; and (4) displaying total charges for recording the transaction.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating an example of the network environment for a service system utilizing the recorder information system of the present invention.

FIG. 2A is a block diagram illustrating an example of a service device utilizing the recorder information system of the present invention, as shown in FIG. 1.

FIG. 2B is a block diagram illustrating an example of a remote client device the recorder information system of the present invention, as shown in FIG. 1.

FIG. 3A are examples of the logical grouping of data in a server database and association with these groups according to the principles of the recorder information system of the present invention, as shown in FIGS. 1, 2A and 2B.

FIG. 3B is a flow chart illustrating an example summary of the maintenance operation of the server database of the present invention, as shown in FIGS. 1, 2A, and 3A.

FIGS. 3C and 3D are a diagrams illustrating an example of the operation of recorder information system of the present invention, as shown in FIGS. 1, 2A, 2B and 3A using the grouping of data, as shown in FIG. 3A.

FIGS. 3E-3K are a diagrams illustrating examples of the types of data for the groups of data in the database of the recorder information system of the present invention, as shown in FIGS. 1, 2A, 2B and 3A using the logic grouping of in the database, as shown in FIG. 3A.

FIG. 4A is a flow chart illustrating an example of the operation of the recorder information system of the present invention on the service device, as shown in FIGS. 1 and 2A.

FIG. 4B is a flow chart illustrating an example of the access of the recorder information system on the remote client device used in conjunction with the recorder information system of the present invention, as shown in FIGS. 2A, 2B, 3A, and 4A.

FIG. 5A is a flow chart illustrating an example of the operation of the basic edition process utilized by the recorder information system of the present invention, as shown in FIGS. 2A and 4A.

FIG. 5B is a flow chart illustrating an example of the operation of the basic info access utilized in the remote client device and utilized by the recorder information system of the present invention, as shown in FIGS. 2B and 4B.

FIG. 6A is a flow chart illustrating an example of the operation of the servicer edition process utilized by the recorder information system of the present invention, as shown in FIGS. 2A and 4A.

FIG. 6B is a flow chart illustrating an example of the operation of the servicer access utilized in the remote client device and utilized by the recorder information system of the present invention, as shown in FIGS. 2B and 4B.

FIG. 7A is a flow chart illustrating an example of the operation of the originator process utilized by the recorder information system of the present invention, as shown in FIGS. 2A and 4A.

FIG. 7B is a flow chart illustrating an example of the operation of the originator access utilized in the remote client device and utilized by the recorder information system of the present invention, as shown in FIGS. 2B and 4B.

FIG. 8A is a flow chart illustrating an example of the operation of the fee wise process utilized by the recorder information system of the present invention, as shown in FIGS. 2A and 4A.

FIG. 8B is a flow chart illustrating an example of the operation of the fee wise access utilized in the remote client device and utilized by the recorder information system of the present invention, as shown in FIGS. 2B and 4B.

FIG. 9 is a flow chart illustrating an example of the operation of the select search process utilized by the recorder information system of the present invention, as shown in FIGS. 2A, 6A and 7A.

FIG. 10A is a flow chart illustrating an example of the operation of the recording office info process utilized by the recorder information system of the present invention, as shown in FIGS. 2A, 6A and 7A.

FIG. 10B is a flow chart illustrating an example of the operation of the recording office info access utilized in the remote client device and utilized by the recorder information system of the present invention, as shown in FIGS. 2B, 6B and 7B.

FIG. 11 is a flow chart illustrating an example of the operation of the fee calculator process utilized by the recorder information system of the present invention, as shown in FIGS. 2A, 6A, 7A and 8A.

FIG. 12 is a flow chart illustrating an example of the operation of the tax calculator process utilized by the recorder information system of the present invention, as shown in 2A, 6A, 7A and 8A.

FIGS. 13A-B are screen prints illustrating an example of the output of the recorder information system of the present invention, as shown in 2A, 6A, and 7A.

FIGS. 14A-B are a data stream illustrating an example of the XML output of the recorder information system of the present invention, as shown in 2A and 8A.

### DETAILED DESCRIPTION OF THE PREFERRED EMBODIMENTS

The present invention relates to a method and means for calculating applicable recording charges for a transaction. The recording charges comprise government recording and transfer charges. The government recording and transfer charges include, but are not limited to, recorder fees and any applicable taxes for a transaction. In particular, relates to a method and system for calculating applicable fees for transactions related to real property, personal property, liens, licenses, certificates, permits and the like.

The recorder information system of the present invention utilizes a database as a repository of city, county and state entities that collect fees and taxes, for real and personal property, liens, licenses, certificates, permits and the like. In particular, the recorder information system provides basic fee and tax information for each of the 3500 plus jurisdictions that collect such fees, as well as complex calculations for more complicated transactions, such as for example, those regarding mortgage transactions. The more complex calculations include information to report and collect the correct amount of recording fees from consumers when generating payoff statements including fees and taxes for the recordation of lien release documents.

The recorder information system can also provide data calculations when preparing good-faith estimates and HUD 1 settlement statements, to disclose, report, collect and pay recording fees, transfer taxes, intangible taxes, mortgage tax stamps and other mortgage transaction fees and taxes. This information can be provided in a WEB-based solution or as an XML data stream solution that can be embedded in other applications.

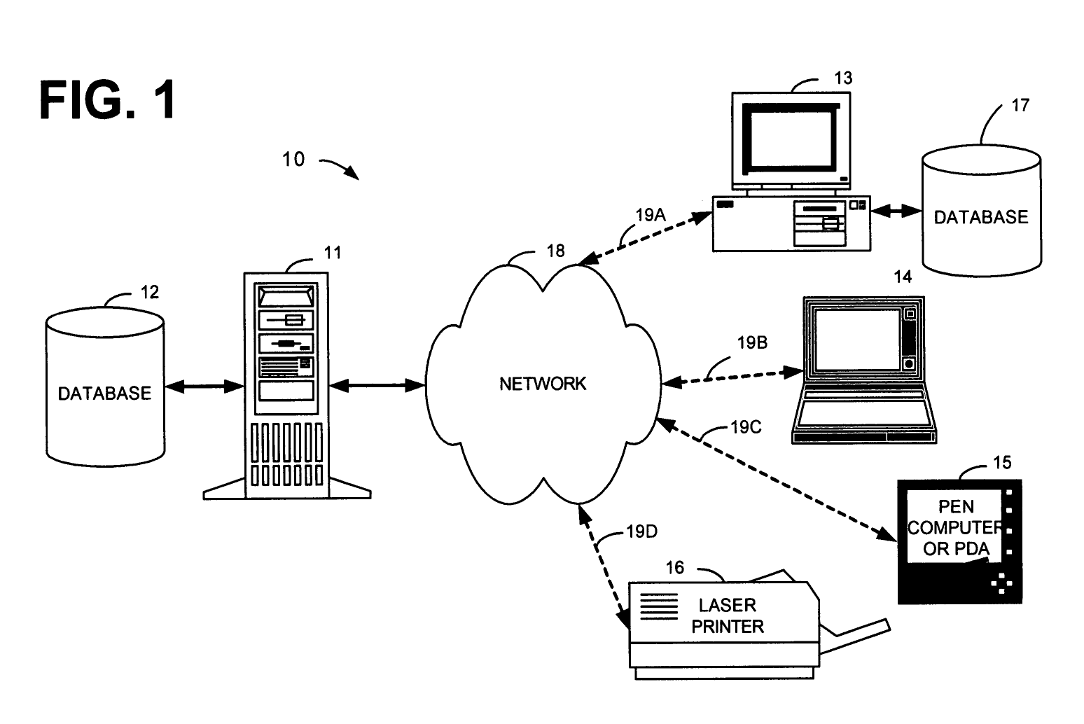

Referring now to the drawings, in which like numerals illustrate like elements throughout the several views, FIG. 1 illustrates an example of the basic components of a system 10 using the recorder information system used in connection with the preferred embodiment of the present invention. The system 10 includes a server 11 and the remote client devices 13, 14, 15 or 16 that utilize the recorder information system of the present invention.

Each remote client device 13 has applications and can have a local database 17. Server 11 contains applications, and a server database 12 that can be accessed by remote client devices 13-16 via connections 19(A-D), respectively, over network 18. The server 11 runs administrative software for a computer network and controls access to itself and database 12. The remote client devices 13-16 may access the database 12 over a network 18, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization.

The remote client devices 13-16 may each be located at remote sites. Remote client devices 13-16 include but are not limited to, PCs, workstations, laptops, handheld computer, pocket PCs, PDAs, pagers, WAP devices, non-WAP devices, cell phones, palm devices, printing devices and the like.

Thus, when a user at one of the remote client devices 13-15 desires to access the current recorder information from the database 12 at the server 11, the remote client device 13-16 communicates over the network 18, to access the server 11 and database 12.

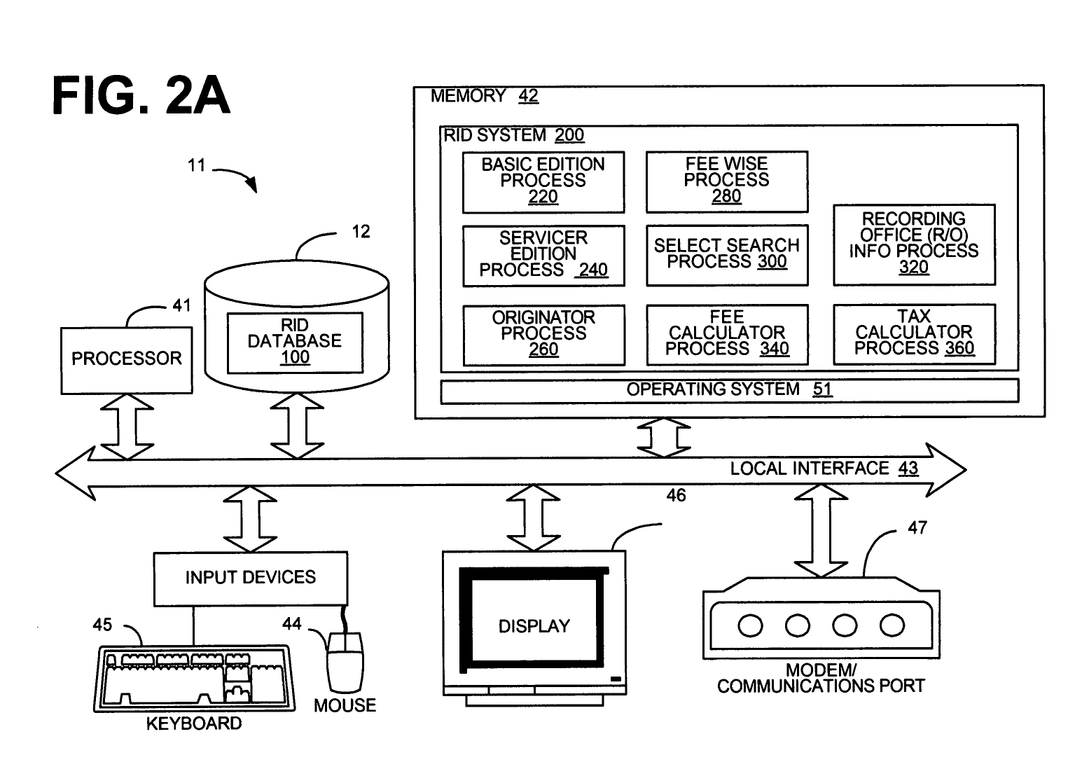

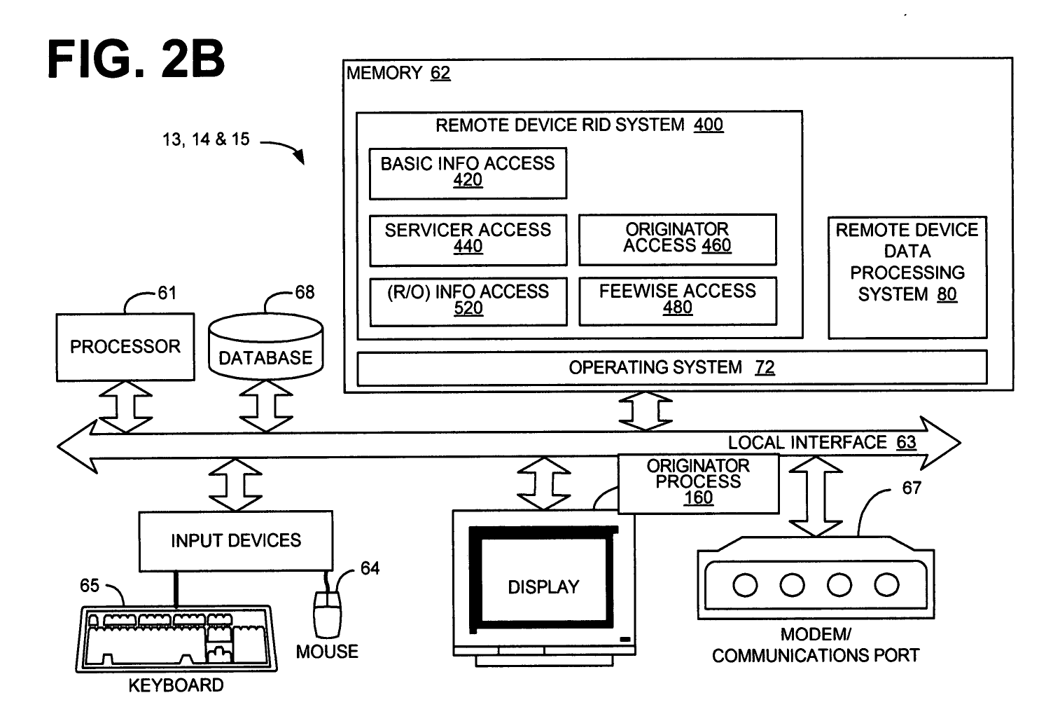

Illustrated in FIG. 2A is a block diagram demonstrating an example of service device 11, as shown in FIG. 1, utilizing the recorder information system 200 of the present invention. Server 11 includes, but is not limited to, PCs, workstations, laptops, PDAs, palm devices and the like. Illustrated in FIG. 2B is an example demonstrating a remote client devices 13 utilizing recorder information system of the present invention. The processing components of the remote power monitoring device 20 are similar to that of the description for the service computer 11-13 (FIG. 2A).

Generally, in terms of hardware architecture, as shown in FIG. 2A, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server computer 11, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 51 and the recorder information system 200 of the present invention. As illustrated, the recorder information system 200 of the present invention comprises numerous functional components including, but not limited to, the basic edition process 220, servicer edition process 240, originator process 260, fee wise process 280, select search process 300, recording office info process 320, fee calculator process 340 and tax calculator process 360.

A non-exhaustive list of examples of suitable commercially available operating systems 51 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 51 essentially controls the execution of other computer programs, such as the recorder information system 200, and provides scheduling, input-output control, file and data management, memory management, and communication control and related services. However, it is contemplated by the inventors that the recorder information system 200 of the present invention is applicable on all other commercially available operating systems.

The recorder information system 200 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 51. Furthermore, the recorder information system 200 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a keyboard 45, mouse 44, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing power system devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 51, and support the transfer of data among the hardware devices. The BIOS is stored in some type of read-only-memory, such as ROM, PROM, EPROM, EEPROM or the like, so that the BIOS can be executed when the server 11 is activated.

When the server 11 are in operation, the processor 41 is configured to execute software stored within the memory 42, to communicate data to and from the memory 42, and to generally control operations of the server 11 are pursuant to the software. The recorder information system 200 and the O/S 51 are read, in whole or in part, by the processor 41, perhaps buffered within the processor 41, and then executed.

When the recorder information system 200 is implemented in software, as is shown in FIG. 2A, it should be noted that the recorder information system 200 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method.

The recorder information system 200 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the recorder information system 200 is implemented in hardware, the recorder information system 200 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of functional elements in the remote client devices 13-15 that enables access to the recorder information system 200 of the present invention, as shown in FIG. 2A. The remote client device 13 provides access to the recorder information residing in database 12. The recorder information accessed in database 12 can be provided in the number of different forms including but not limited to ASCII data, WEB page data (i.e. HTML), XML or other type of formatted data. As illustrated, the remote client device 13-15 includes many of the same components as server 11 described with regard to FIG. 2A. Hereinafter, the remote client device is device 13-15 will be referred to as remote client devices 13 for the sake of brevity.

Located in memory 62 is the remote client device recorder information system 400, which includes, but is not limited to, the basic info access 420, servicer access 440, originator access 460, fee wise access 480 and recorder info access 520. When the recorder information system 400 is implemented in software, as is shown in FIG. 2B, it can be stored on virtually any computer readable medium for use by or in connection with any computer related system or method.

In an alternative embodiment, where the remote client device recorder information system 400 is implemented in hardware, the recorder information system 400 can be implemented in the same way as described above with regard to the data synchronization system 100 (FIG. 2A).

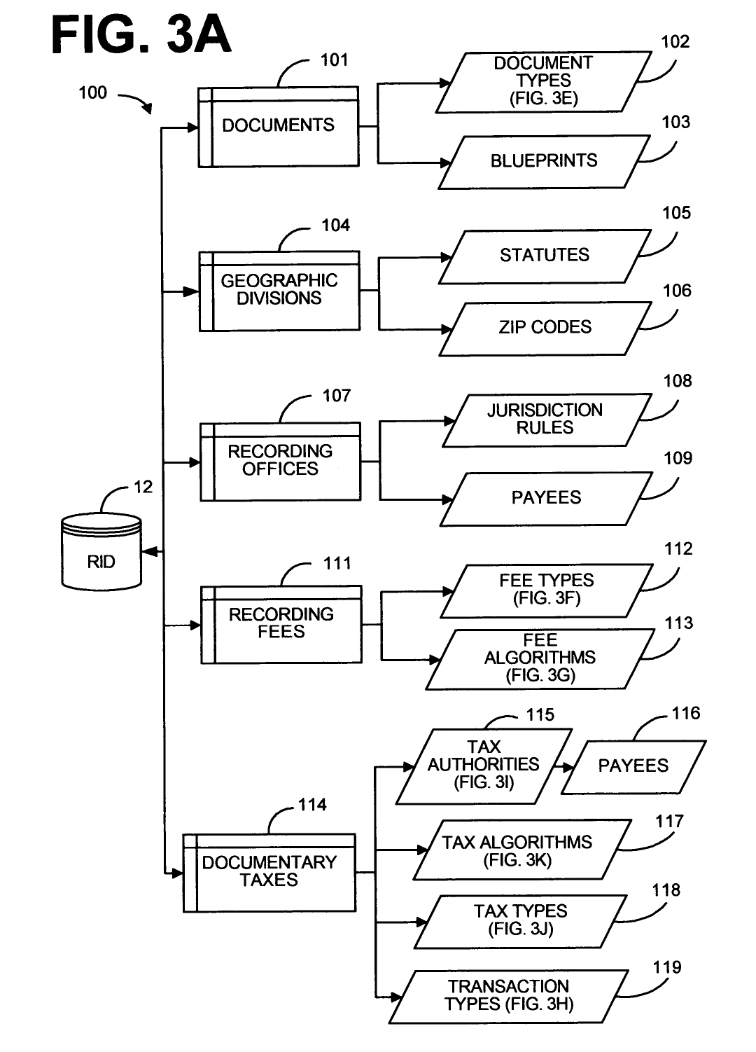

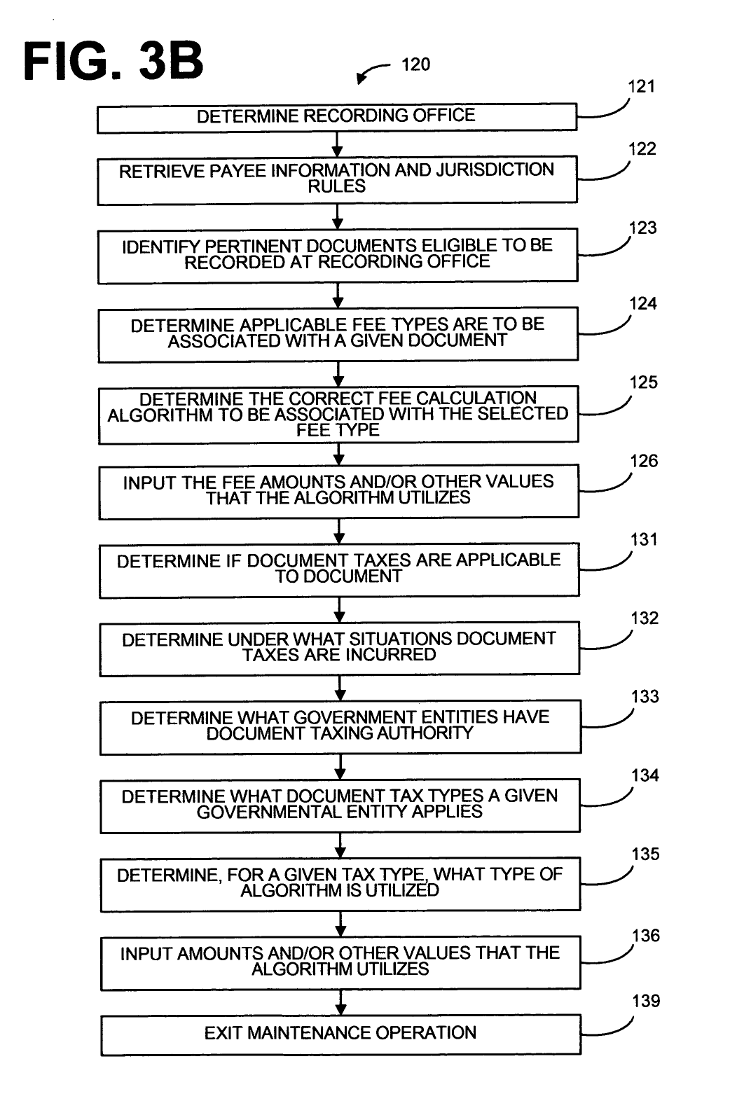

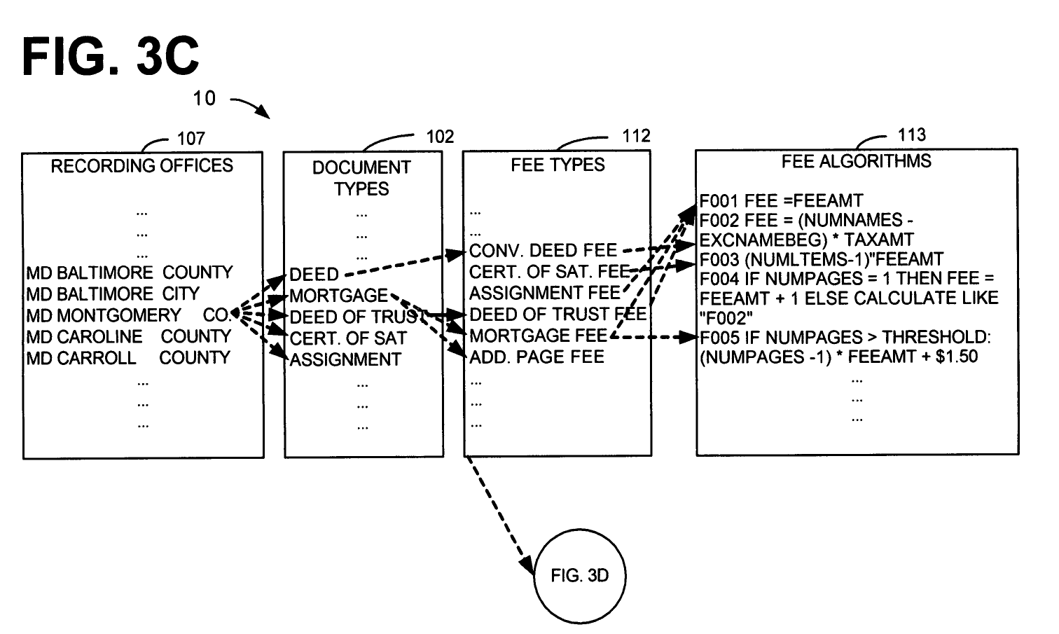

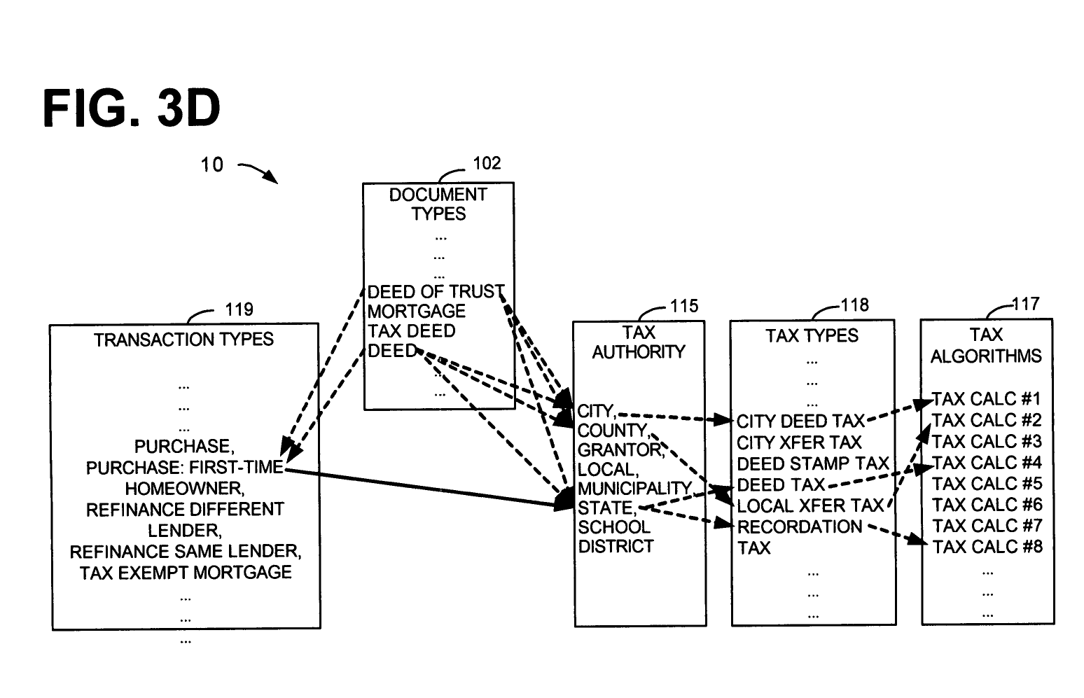

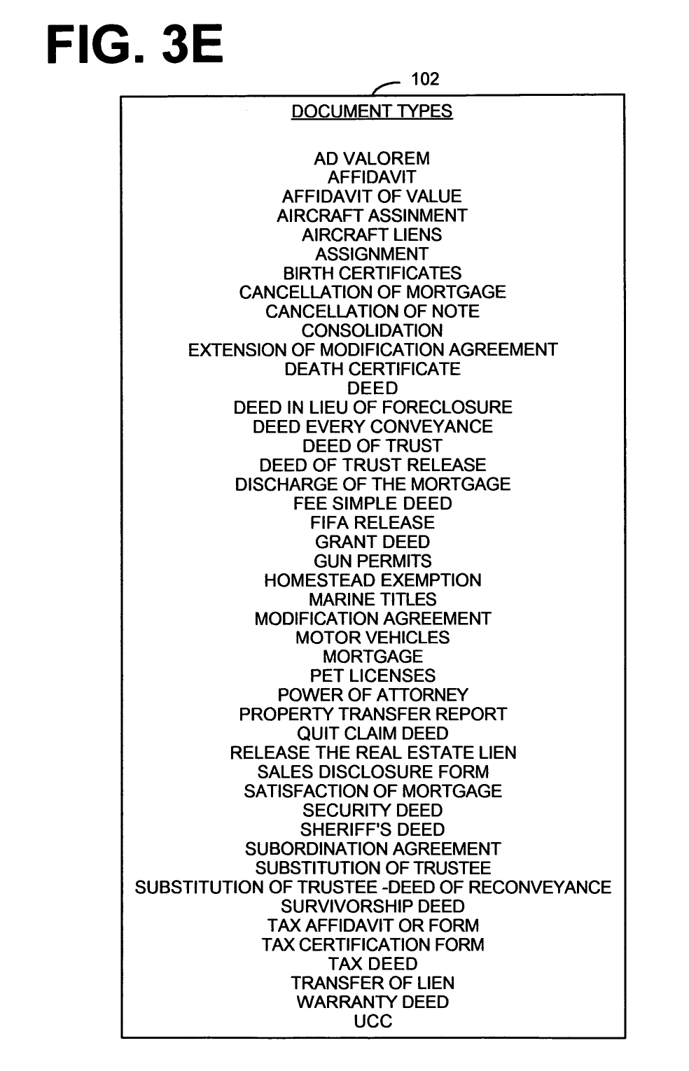

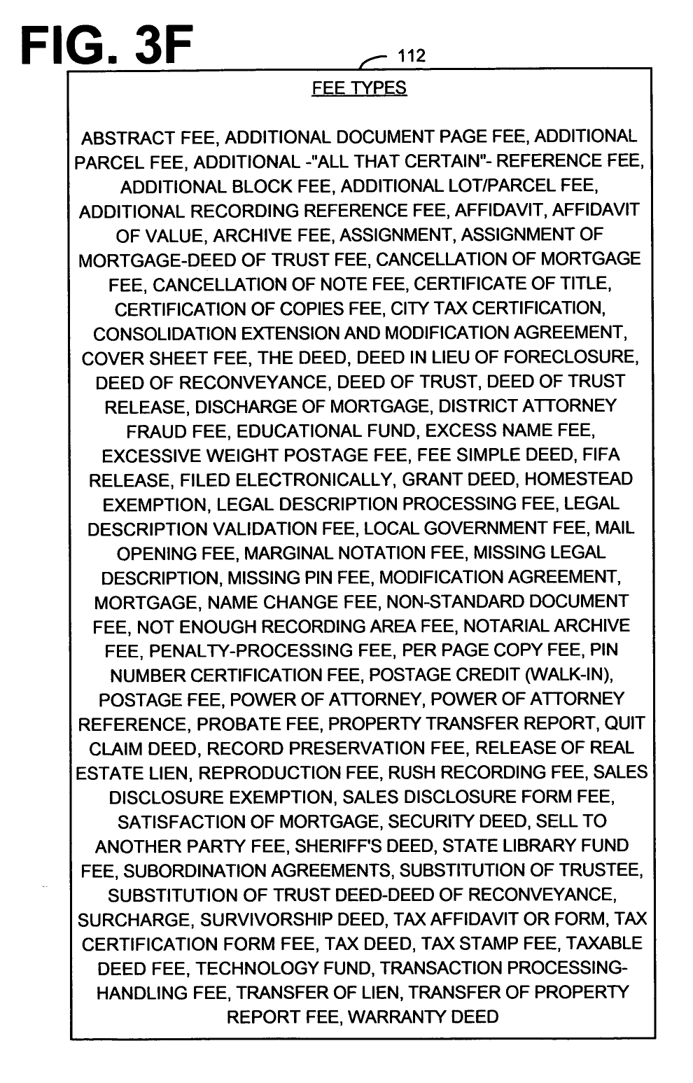

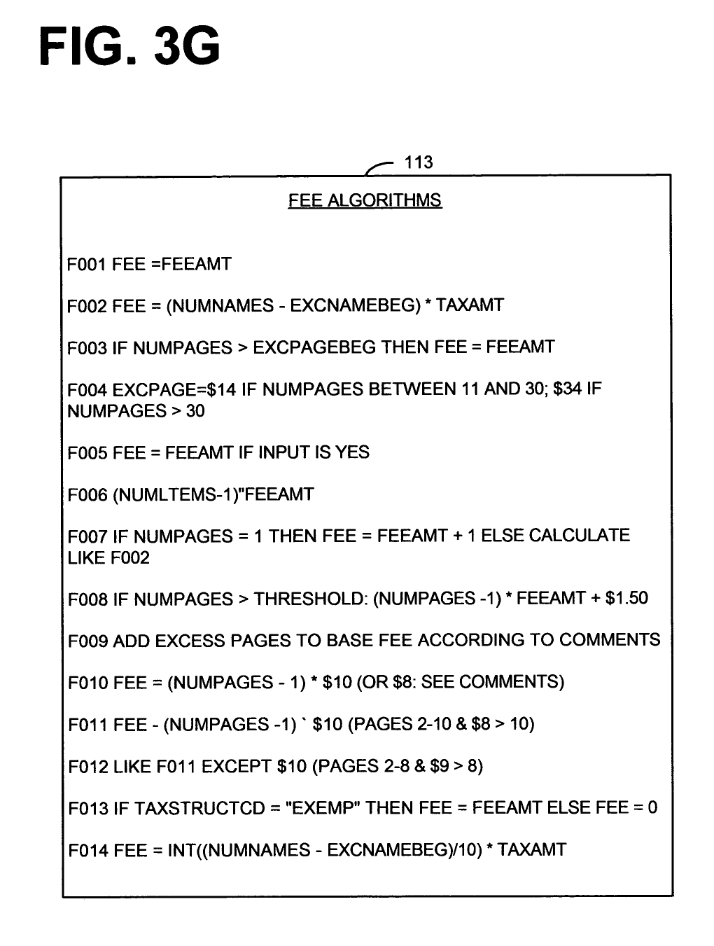

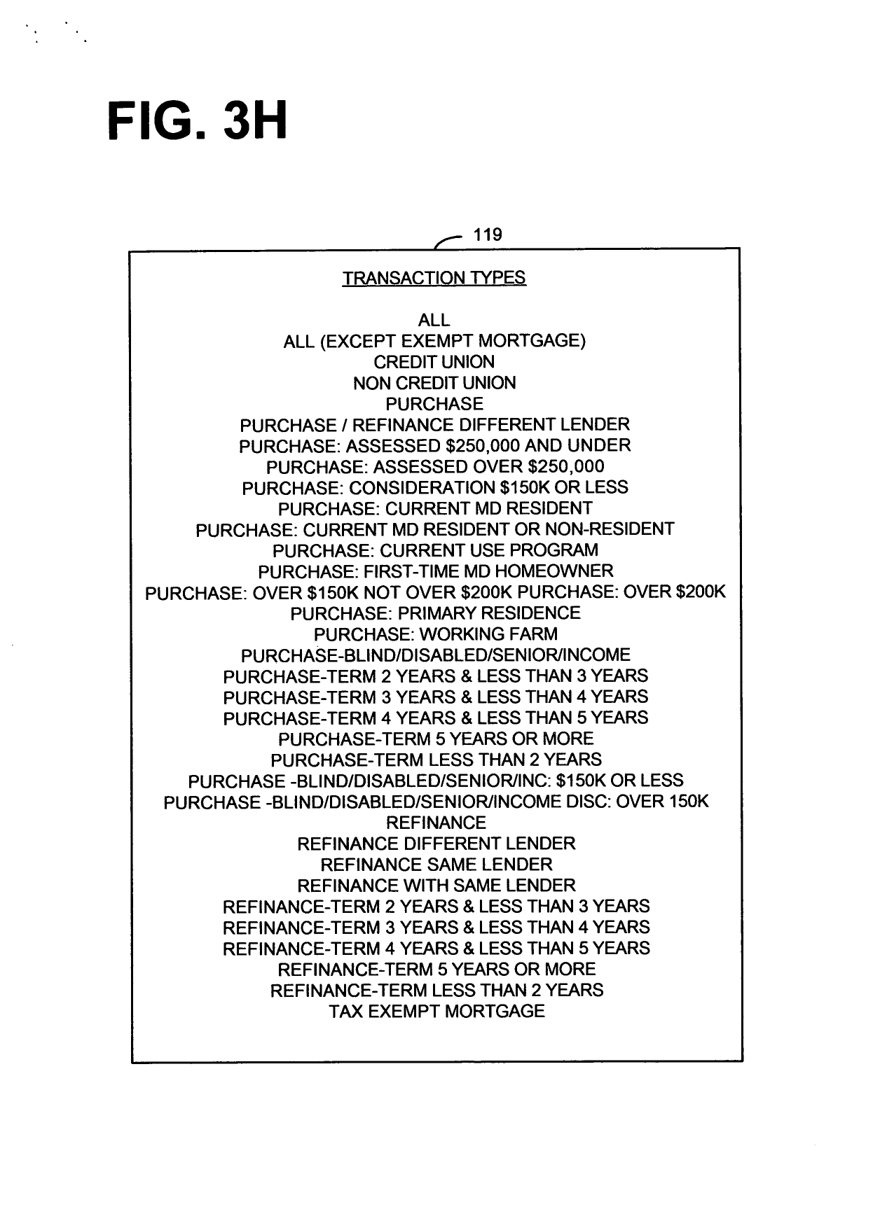

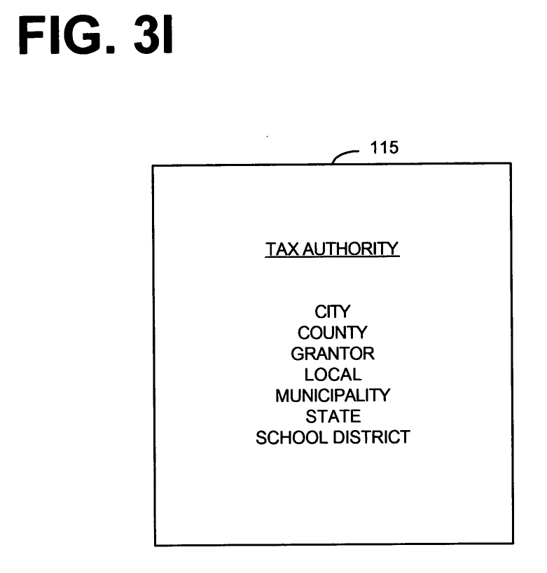

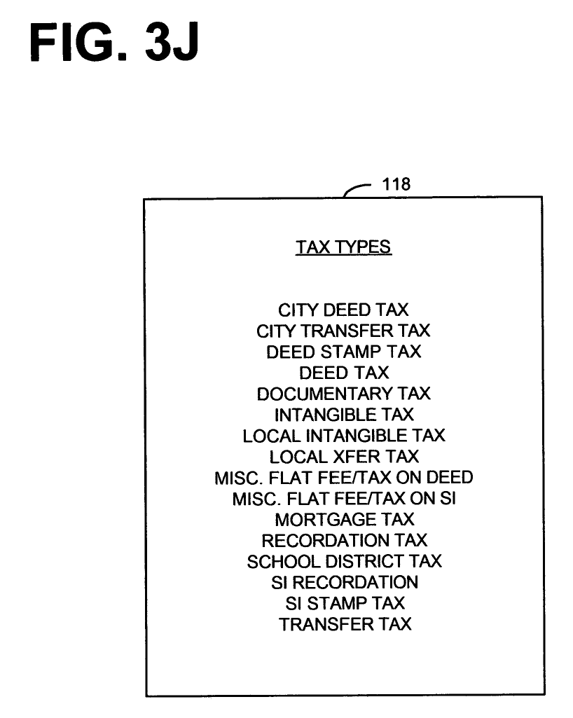

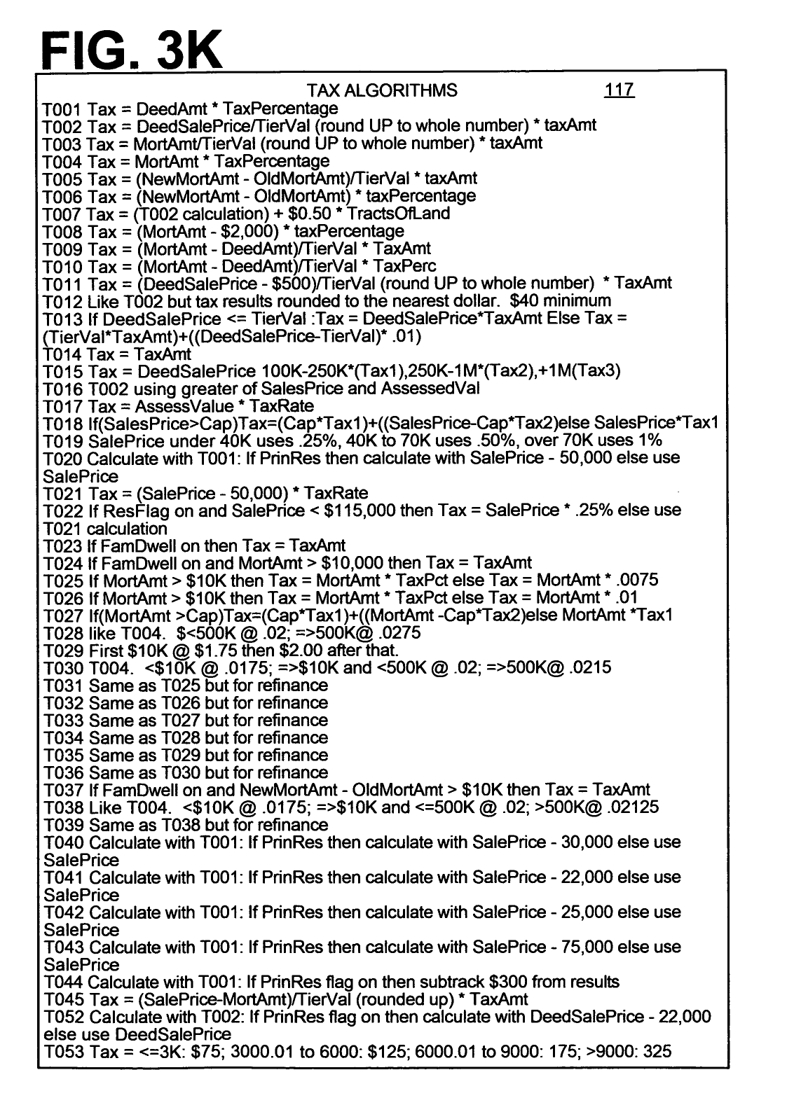

FIG. 3A is an example illustrating of the logical grouping of data in a server database and association of these groups according to the recorder information system of the present invention, as shown in FIGS. 1, 2A and 2B. The database 12 comprises the recorder information database (RID) 100. The illustrated example RID 100 data comprises the groupings of documents 101, geographic divisions 104, recording offices 107, recording fees 111 and documentary taxes 114 data types.

The document types 101 data further include document types 102 and a blueprint data 103. The document types 101 of data comprise the various different types of documents that are collected for in the RID 100. The document type 102 data is here in described in further detail with regard to FIG. 3E.

The geographic divisions 104 further include statutes 105 and zip codes 106 information. The documents and the statutes 105 portion include all relevant statutes for any and all taxes and fees that are applicable to the 3700 plus recording offices across the country. The zip code 106 portion includes pointers to associated recording offices for searching capabilities.

The recording offices 107 portion further includes jurisdiction rules 108 and payees 109. The jurisdiction rules 108 are a collection of rules concerning the applicable fees to each of the 3700 plus recording offices 107. The payees 109 include identification of city, municipality, county, state or other governmental entities are applicable for payments. There can be multiple payees 109 occurring for each recording office 107.

The recording fees 111 further include fee types 112 and fee algorithms 113. The fee types 112 identify each type of the fee payable in each recording office 107 in the 3700 plus recording offices across the country. The fee types 112 data is herein described in further detail with regard to FIG. 3F. The fee algorithm 113 portion include fee algorithms for computing a fee amount for each fee type in each recording office. The fee algorithm 113 data is herein defined in further detail with regard to FIG. 3G.

The documentary taxes 114 further include taxing authority 115, payees 116, tax algorithms 117, tax types one the 18 and transactional types 119. The taxing authority 115 designates each governmental entity capable of imposing taxes or fees for a transaction collected by the recording office. Taxing authority 115 portion is herein defined in further detail with regard to FIG. 3I.

Payees 116 indicate fee entity receiving payment of fees or taxes. The tax algorithms 117 portion identifies each and every tax calculation for every transaction in recording offices 107. The taxing algorithms 117 data is herein defined in further detail with regard to FIG. 3K. Tax types 118 identifies each and every type of taxes imposed by taxing authority 115, in each of the 3700 plus recording offices across the country. The tax type 118 is herein defined in further detail with regard to FIG. 3J. The transaction types 119 indicate what type of taxable transaction is creating a duty to pay a tax in each of the 3700 plus recording offices across the country. The transaction types 119 are herein defined in further detail with regard to FIG. 3H.

FIG. 3B is a flow chart illustrating an example summary of the maintenance operation 120 of the server database 12 of the present invention, as shown in FIGS. 1, 2A, and 3A. The maintenance operation 120 of the recorder information system 200 of the present invention follows the illustrated methodology. It is understood that many of these steps can be executed concurrently, out of order or may be repetitive, iterative and or certain sequences may be performed multiple times from what is shown.

The maintenance operation 120 of the server database 12 of the present invention first determines the recording office for the transaction to be processed at step 121. The payee and jurisdiction rules are then obtained at step 122.

The maintenance operation 120 identifies pertinent document eligible to be recorded at a recording office at of 123. At step 124 it is determined what applicable fee types are to be associated with the given document to be recorded. At step 125, the recording information system 200 of the present invention then determines the correct calculation algorithm to be associated and applied with the selected fee type.

Next, maintenance operation 120 allows the user to inputs any fees and/or other values that the fee algorithm utilizes in the calculating the fee. At step 131, the maintenance operation 120 determines if document taxes are applicable to the document being processed. At step 132, the maintenance operation 120 determines what situations document taxes will be applicable to the current document being processed. At step 133, it is determined what government entities have any required taxes for the document being processed. At step 134, it is determined what document tax types a given governmental entity applies to be document being processed.

At step 135, it is determined what type of algorithm is utilized for any applicable tax type. All the algorithms are then run using amounts and other values that the applicable algorithms need for processing, and then generate the fee and tax totals. The maintenance operation 120 then exits at step 139.

FIGS. 3C and 3D are diagrams illustrating an example of the operation of recorder information system 200 of the present invention, as shown in FIGS. 1, 2A, and 2B, using the logical grouping of data, as shown in FIG. 3A., and, the method flow as shown in FIG. 3B. FIGS. 3C and 3D are provided to illustrate an example of the multilevel functionality of the recorder information database 100. The instant example is for illustrative purposes only.

As seen in FIG. 3C, the recording offices 107 data indicate for all the entities in document types 102 that can be recorded in a single entity recording offices 107 portion. In the illustrated example an entity in the recording offices 107 portion indicates that the three document types 102 are available for recording. The instant example is for illustrative purposes only. In this example, the recording office entity, “Montgomery County” is indicated to have the document types 102 entities, deed of trust, mortgage, deed, certificate of satisfaction and assignment as available documents. A mortgage is one type of a security instrument. Other types of security instruments include but are not limited to deeds of trust, mortgages, and the like. Deeds include warranty deeds, grant deeds, and the like.

FIG. 3C further shows that each entity in document types 102 has a link to each associated entity in fee types 112. However, it is not illustrated in this particular example that each entity in document type 102 may associate with more then one entity in fee types 112 however, it is still possible to have multiple associations. Then each entity in fee types 112 has at least one associated entity in fee algorithms 113. As shown, it is possible for multiple entities in fee types 112 to reference the same entity in the algorithms 113. It is also possible as illustrated to have one entity in fee types 112 reference multiple entities in fee algorithms 113.

FIGS. 3C and 3D illustrate the further linkage of entities in document type 102 with transaction types 119. As seen in FIG. 3D, each of the entities in document types 102 is associated with an entity in transaction types 119. The instant example is for illustrative purposes only. In the instant example, the transaction type 119 links each individual transaction being recorded at a particular recording office entity in recording offices 107. In the instant example, transaction type entity is a purchase for a first-time homeowner. Moreover in the instant example, for the first-time homeowner, there are related entities in tax authority 115 that are applicable. The taxing authorities are also related to entities in document types 102. In the instant case, the applicable entity in document types 102 is linked to multiple entities in tax authority 115. Again, this is to illustrate the multi-access capability of the recorder information database 100.

For each entity in tax authorities 115 there are related entities in tax types 118. Illustrated is the notion that an entity in tax authority 115 may reference more than one entity in tax types 118. What's not illustrated but still possible is that multiple entities in tax authority 115 may reference the same entity in tax type 118. For each entity in tax types 118, there is a reference to an entity in tax algorithms 117. It is possible to have multiple entities in tax algorithms 118 referenced by a single entity tax types 118.

FIGS. 3E-3K are a diagrams illustrating examples of the types of data for the groups of data in the database 100 of the recorder information system 200 of the present invention, as shown in FIGS. 1, 2A, 2B and 3A using the logic grouping of in the database 100, as shown in FIG. 3A.

FIG. 3E illustrates an example of document types 102 data comprising the various different types of documents that are collected in the RID 100. The example document type 102 data includes, but is not limited to the following types of documents listed. The primary documents for loan transactions are mortgages and deeds. The secondary documents for loan transactions include, but are not limited to, affidavits, assignments, cancellation of mortgage, deed of trust, power of attorney, release of real estate lien, satisfaction of mortgage, substitution of trustee, and substitution of trustee-deed of reconveyance. Non-standard documents are non-compliant documents with the rules, regulations and statutes under the state or local jurisdiction as enforced by the recording office.

FIG. 3F illustrates an example of fee types 112 data comprising the various different types of fees payable in each recording office 107, in the 3700 plus recording offices across the country, that are collected in the RID 100. The example fee types 112 data includes, but is not limited to the following types of fee types listed. For the purposes of this document references to parcels or lots shall hereafter be referred to as parcels for the sake of brevity.

FIG. 3G illustrates an example of fee algorithms 113 data comprising the various different types of fee algorithms for computing a fee amount for each fee type in each recording office 107, in the 3700 plus recording offices across the country, that are collected in the RID 100. The example fee types 112 data includes, but is not limited to the following types of fee algorithms listed.

FIG. 3H illustrates an example of transaction types 119 data comprising the various different types of transactions creating a duty to pay a fee or tax in each recording office 107, in the 3700 plus recording offices across the country, that are collected in the RID 100. The example transaction types 119 data includes, but is not limited to the following types of transactions listed.

FIG. 3I illustrates an example of taxing authority 115 data designates each recording office 107 capable of imposing taxes or fees for a transaction, in the 3700 plus recording offices across the country, that are collected in the RID 100. The example taxing authority 115 data includes, but is not limited to the following taxing authorities listed.

FIG. 3J illustrates an example of tax types 118 data identifies each and every type of tax imposed by taxing authority 115, in each of the 3700 plus recording offices across the country, that are collected in the RID 100. The example tax types 118 data includes, but is not limited to the following tax types listed.

FIG. 3K illustrates an example of tax algorithms 117 data identifies each and every tax calculation applicable for every transaction in recording offices 107, which are collected in the RID 100. The example tax algorithms 117 data includes, but is not limited to the following tax calculations listed. One example is for the state of Vermont, who utilizes a tiered approach to its taxing of a deed tax. In an example for Vermont, the first hundred thousand dollars of the purchase price are taxed at a first rate, and any amount of the purchase price exceeding $100,000 is taxed at a second rate. At this time, the first tax rate is $0.005, or the second tax rate is at $0.0125. Another example is for the state of Illinois, determining if a city tax is due for a taxing authority in Illinois, other than Chicago. The city tax is calculated the city tax for the taxing authority in Illinois other than Chicago and providing the city deed tax to a remote client device.

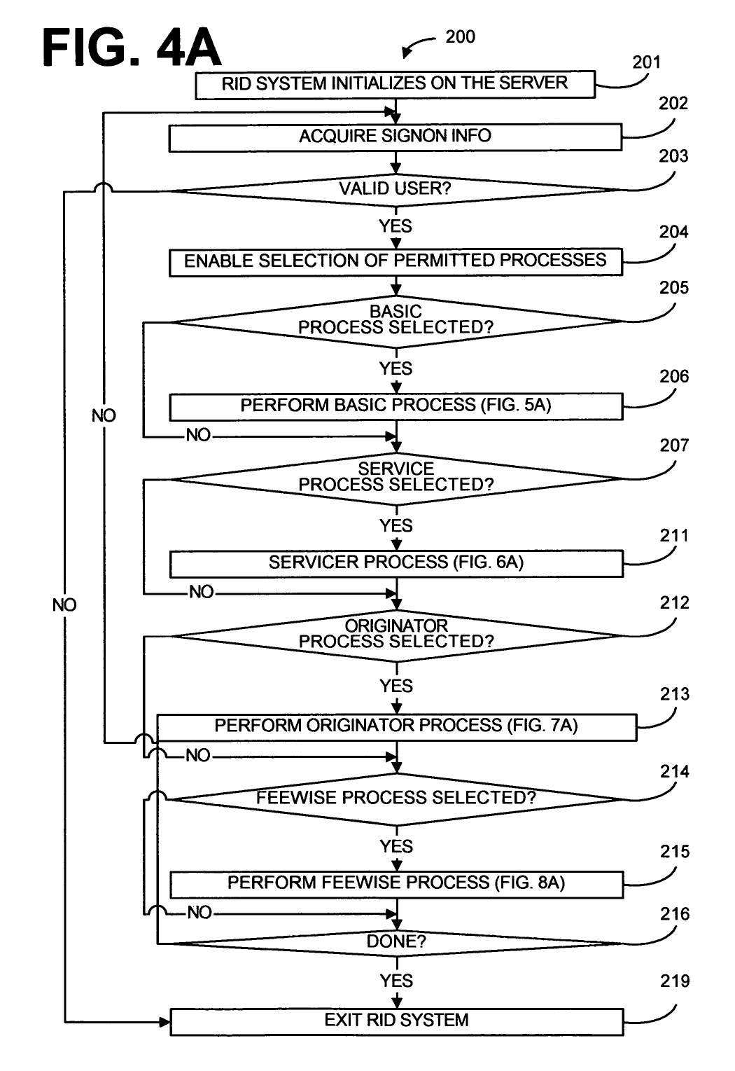

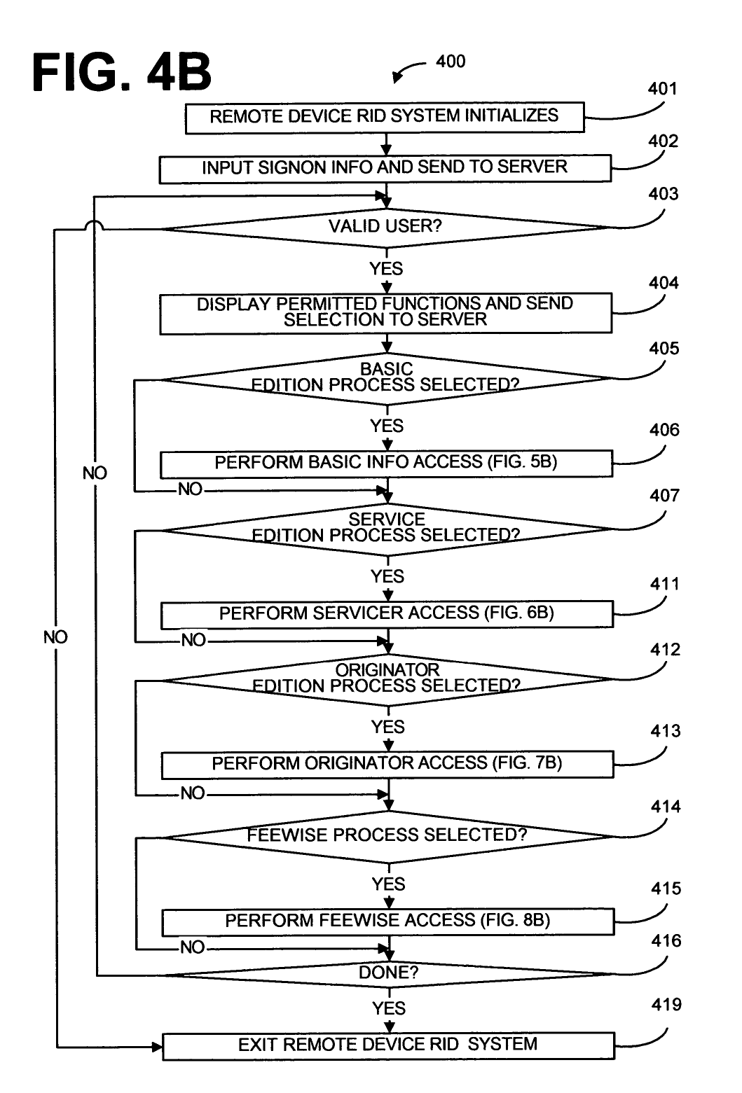

FIG. 4A is a flow chart illustrating an example of the operation of the recorder information system 200 of the present invention on the server 11, as shown in FIGS. 1 and 2A. The recorder information system 200 running on server 11 enables a user access to listings above fees and taxes applicable to certain transactions, as well as calculators for computing fees and taxes for applicable transactions.

First at step 201, the recorder information system 200 is initialized. This initialization includes the startup routines and processes embedded in the BIOS of the server 11. The initialization also includes the establishment of data values for particular data structures utilized in the recorder information system (RIS) 200. At step 202, the server 11 acquires sign on information from the user of the remote client devices 13. The recorder information system 200 then determines if the user is valid at step 203. If it is determined at step 203 that the user is not valid, then the recorder information system 200 exits at step 219.

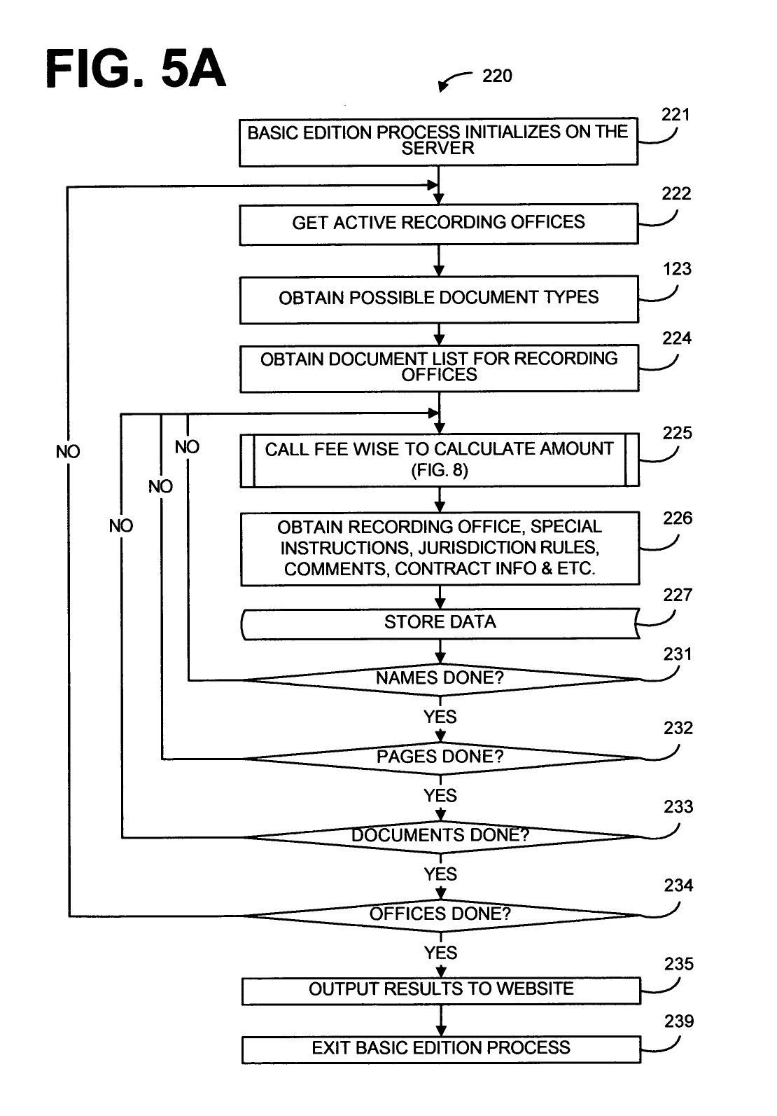

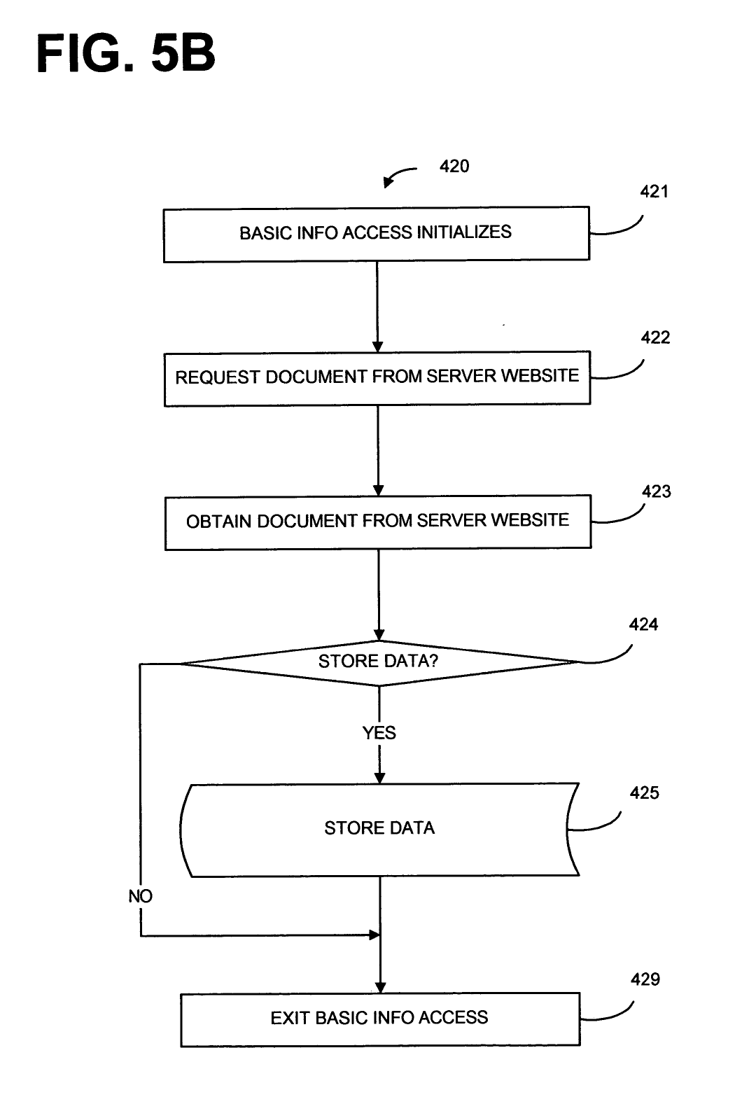

However, if it is determined at step 203 that the user is valid, then the recorder information system 200 enables the user to select a permitted process at step 204. After enabling the user to make the selection the recorder information system 200 determines in the user has selected the basic process at step 205. It is determined at step 205 that the user has not selected the basic process, then the recorder information system 200 proceeds to step 207. However, it is determined at step 205 that the basic process has been selected, then be recorder information system 200 performs the basic process herein defined in further detail with regard to FIG. 5A.

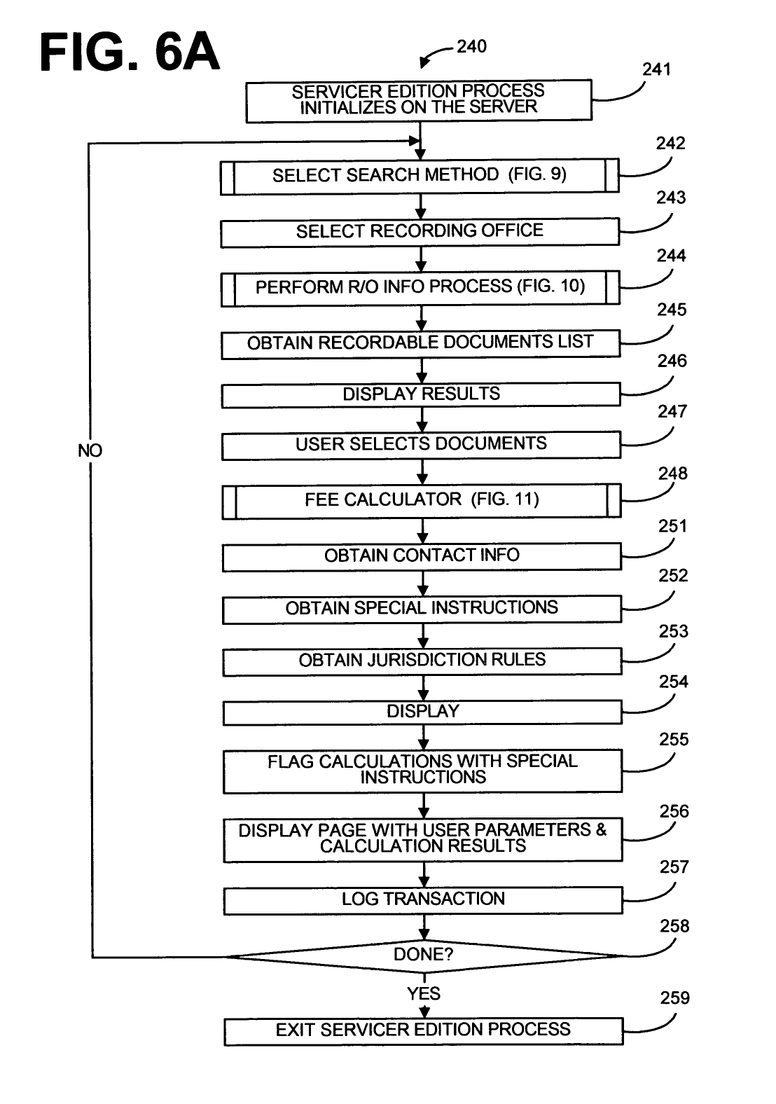

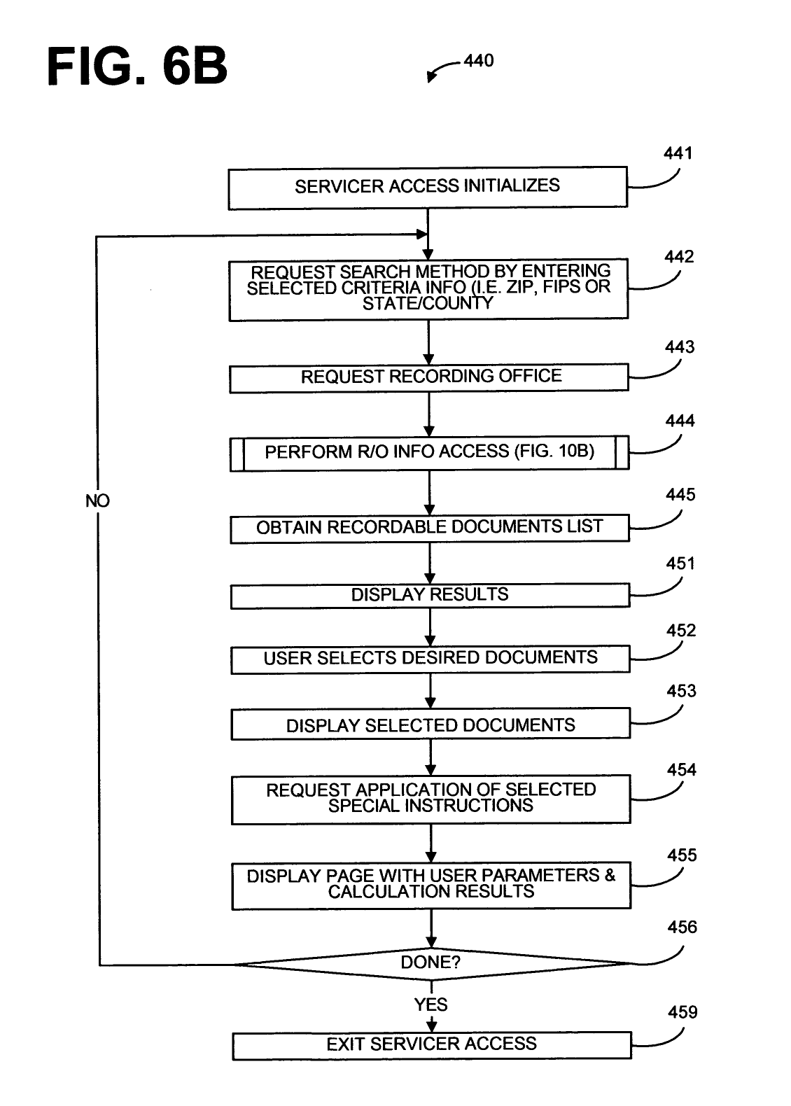

At step 207, the recorder information system 200 determines if the user has selected the service process. At the determined at step 207 that the user has selected the service process, then the servicer process is performed at step 211. The servicer process as herein defined further detail with regard to FIG. 6A.

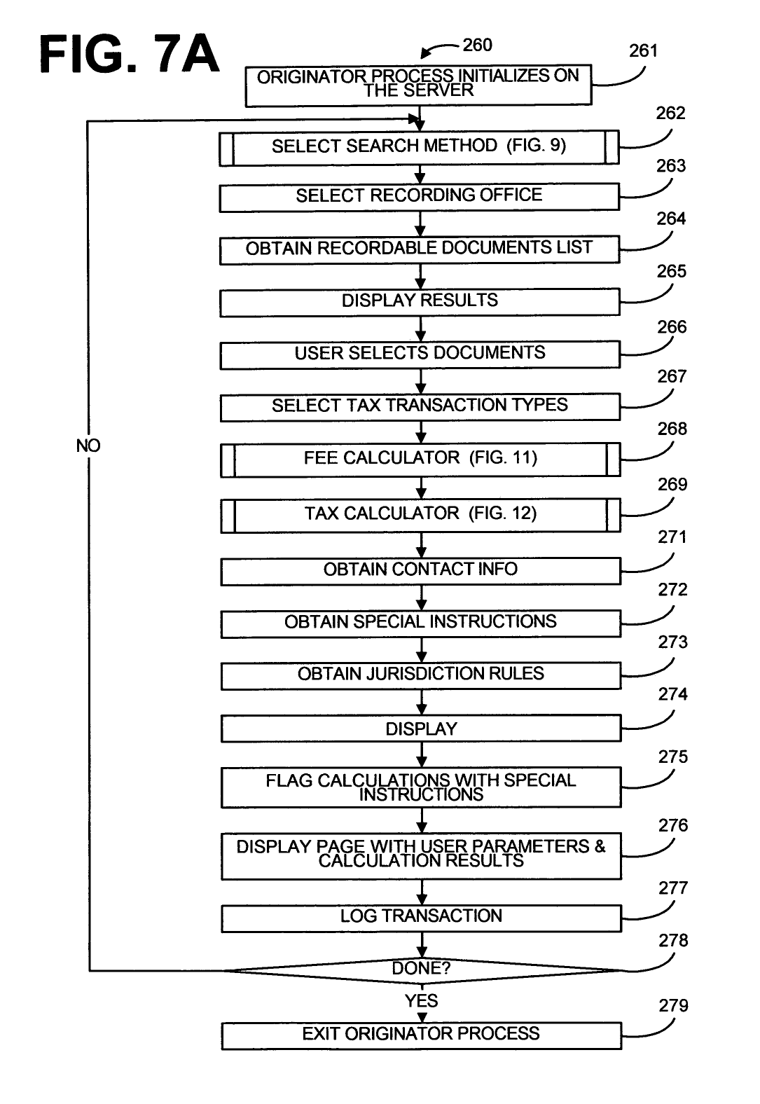

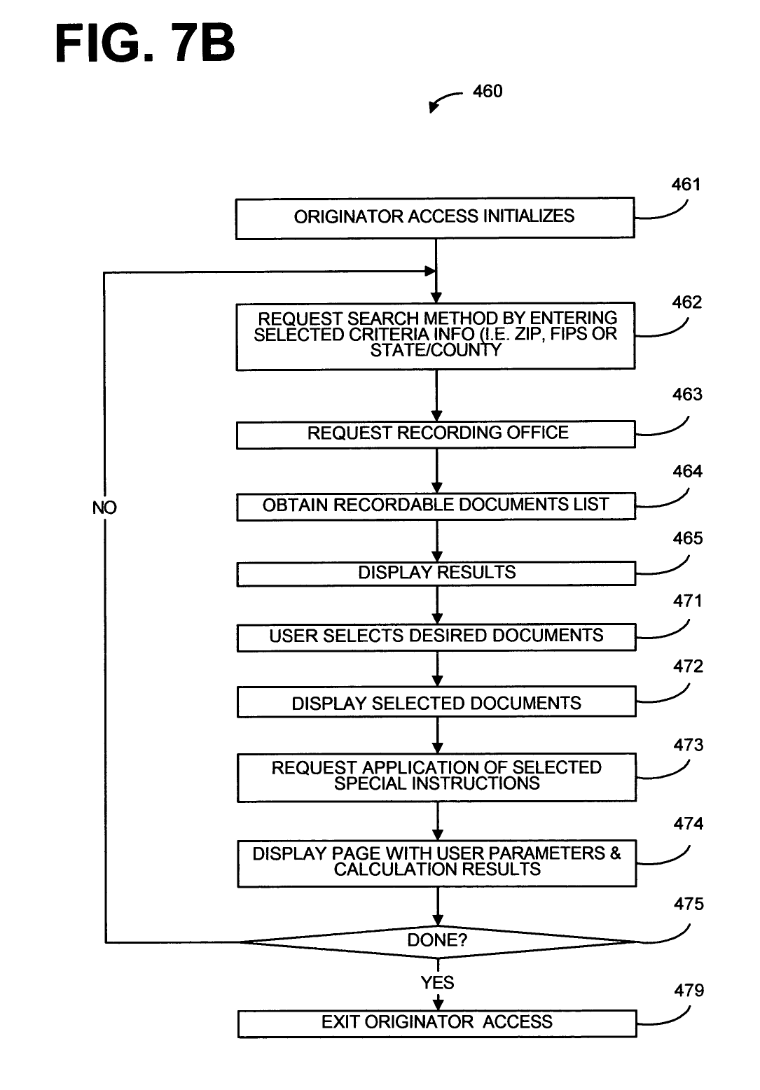

At step 212, the recorder information system 200 determines if the user has selected the originator process. At the determined at step 212 that the user has selected the originator process, then the originator process is performed at step 213. The originator process as herein defined further detail with regard to FIG. 7A.

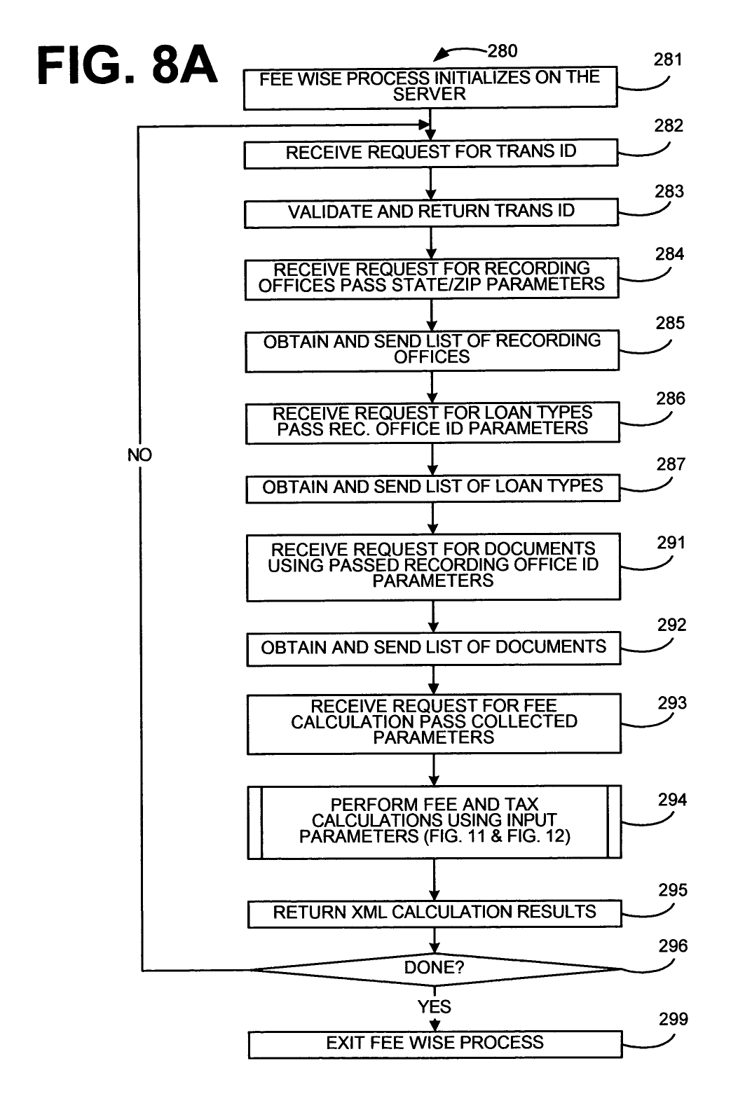

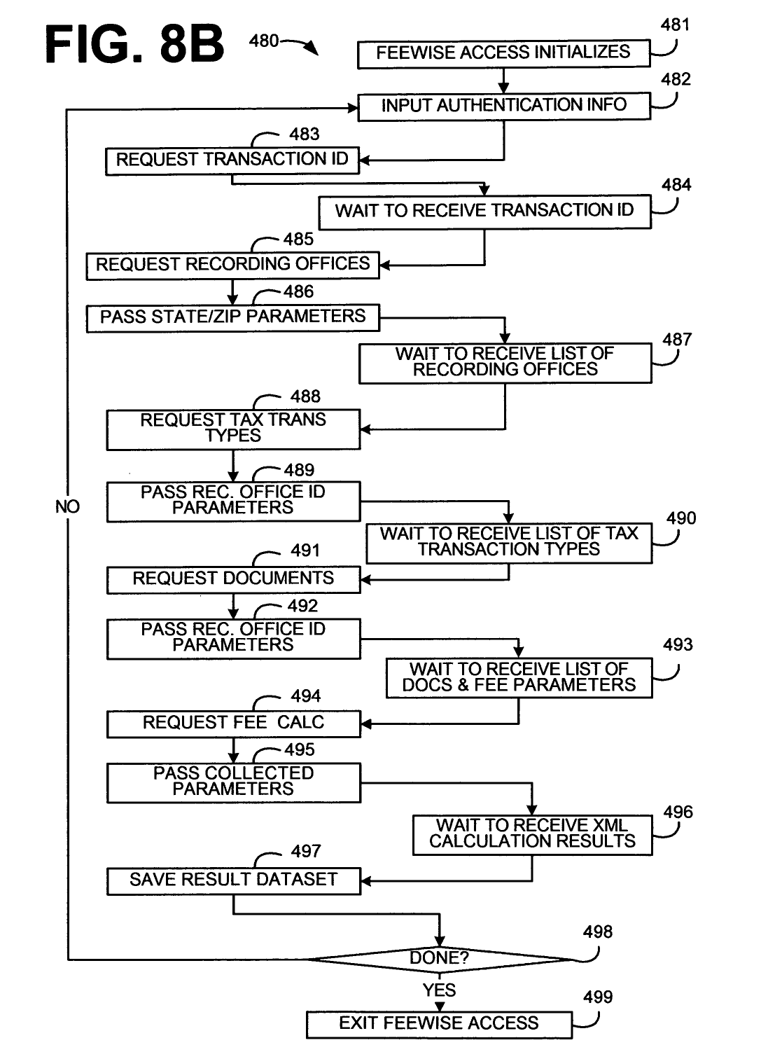

At step 214, the recorder information system 200 determines if the user has selected the feewise process. At the determined at step 214 that the user has selected the feewise process, then the feewise process is performed at step 215. The feewise process as herein defined further detail with regard to FIG. 8A.

At step 216, it is determined if there are more activities to be processed. If it is determined that there are more activities to be processed, the recorder information system 200 returns to repeat steps 202 through 216. However, if it is determined at step 216 that there are no more activities to be processed, then the recorder information system 200 exits at step 219.

FIG. 4B is a flow chart illustrating an example of the operation of the remote device recorder information data system 400 on the remote client devices 13 used in conjunction with the recorder information system 200 of the present invention, as shown in FIGS. 2A, 2B, and 4A. The remote device recorder information data system 400 processes all interaction with the server 11 and shall hereafter be referred to as remote recorder system 400.

First at step 401, the remote recorder system 400 is initialized. This initialization includes the startup routines and processes embedded in the BIOS of the remote client devices 13. The initialization also includes the establishment of data values for particular data structures utilized in the remote recorder system 400. At step 402, the remote recorder system 400 waits for the user to input sign on information and send to server 11.

Next, at step 403, the remote recorder system 400 determines if the server 11 accepted the user as a valid user. It is determined if the user was deemed invalid by a server 11, then the remote recorder system 400 proceeds to step 419 to exit. However, it is determined at step 403 that the user is a valid user, then the remote recorder system 400 displays permitted functions for selection by the user that is sent to sever 11 for process. After receiving an indication from server 11 that the user is valid, the remote recorder system 400 then displays permitted functions and accepts the input from the user on which function to perform and sends that selection to server 11.

At step 405, it is determined by the remote recorder system 400 if the basic edition process was selected. If it is determined at step 405 that the basic edition process was not selected, then the remote recorder system 400 proceeds to step 407. However, it is determined at step 405 that the basic process was selected, then the remote recorder system 400 performs the basic info access at step 406. The basic info access is herein defined in further detail with regard to FIG. 5B.

At step 407, it is determined by the remote recorder system 400 if the service edition process was selected. If it is determined at step 407 that the service edition process was not selected, then the remote recorder system 400 proceeds to step 412. However, it is determined at step 407 that the service process was selected, then the remote recorder system 400 performs the servicer access at step 411. The servicer info access is herein defined in further detail with regard to FIG. 6B.

At step 412, it is determined by the remote recorder system 400 if the originator edition process was selected. If it is determined at step 412 that the originator edition process was not selected, then the remote recorder system 400 proceeds to step 414. However, it is determined at step 412 that the originator process was selected, then the remote recorder system 400 performs the originator access at step 413. The originator access is herein defined in further detail with regard to FIG. 7B.

At step 414, it is determined by the remote recorder system 400 if the feewise process was selected. If it is determined at step 414 that the feewise process was not selected, then the remote recorder system 400 proceeds to step 416. However, it is determined at step 414 that the feewise process was selected, then the remote recorder system 400 performs the feewise access at step 415. The basic info access is herein defined in further detail with regard to FIG. 8B.

At step 416, it is determined if there are more activities to be processed. If it is determined that there are more activities to be processed, the remote recorder system 400 returns to repeat steps 402 through 416. However, if it is determined at step 416 that there are no more activities to be processed, then the remote recorder system 400 exits at step 419.

FIG. 5A is a flow chart illustrating an example of the operation of the basic edition process 220 utilized by the recorder information system 200 of the present invention, as shown in FIGS. 2A and 4A. The basic edition process 220 enables the remote client devices 13 to download recording office information from the service device 11. This information is provided in a web form for illustration purposes. However, in alternative embodiment may be available in a flat file, spreadsheet, access database or other type of non-interactive form.

First at step 221, the basic edition process 220 is initialized. This initialization includes the startup routines and processes embedded in the BIOS of the server 11. The initialization also includes the establishment of data values for particular data structures utilized in the basic edition process 220.

At step 222, the basic edition process 220 attempts to obtain an active recording office information. At step 223, it obtains possible document types and at step 224 obtain a document lists for all available recording offices. At step 225, the basic edition process 220 then performs the feewise process. The feewise process is herein defined in further detail with regard to FIG. 8A.

At step 226, the basic edition process 220 obtains recording offices, special instruction, jurisdiction rules, comments, contacts and the like. This information is then stored in database 12 at step 226. At step 231, it is determined if there are more names to be processed to determine any excessive name fee. If it is determined that there are more names to be processed, the basic edition process 220 returns to repeat steps 225 through 231. However, that is determined at step 231 that there are no more names to be processed, then the basic edition process 220 proceeds to step 232 if there are more pages to be processed.

At step 232, the basic edition process 220 determines if there are more pages to be processed. It is this determined at step 232 that there are more pages to be processed to determine the actual page of fee, then the basic edition process 220 returns to repeat steps 225 through 232. However, and it is determined is that there are no more pages to be processed, then the basic edition process 220 proceeds to step 233 to determine if there are more documents to be processed.

At step 233, the basic edition process 220 determines if there are more documents to be processed. It is this determined at step 233 that there are more documents to be processed, then the basic edition process 220 returns to repeat steps 225 through 233. However, if it is determined is that there are no more documents to be processed, then the basic edition process 220 proceeds to step 234 to determine if there are more recording offices to be processed.

At step 234, the basic edition process 220 determines if there are more recording offices to be processed. It is this determined at step 234 that there are more recording offices to be processed, then the basic edition process 220 returns to repeat steps 225 through 234. However it is determined is that there are no more recording offices to be processed, then the basic edition process 220 proceeds to step 235.

At step 235, the basic edition process 220 outputs the results to a web site. In the preferred embodiment, this information is provided as a spreadsheet. However, alternate methods of providing the output result can be utilized. The basic edition process 220 exits at step 239.

FIG. 5B is a flow chart illustrating an example of the operation of the basic info access 420 utilized in the remote client devices 13 and utilized by the recorder information system 200 of the present invention, as shown in FIGS. 2B and 4B. The basic info access 420 enables the remote client devices 13 to download recorder information data from service device 11.

First at step 421, the basic info access 420 is initialized. This initialization includes the startup routines and processes embedded in the BIOS of the remote client devices 13. The initialization also includes the establishment of data values for particular data structures utilized in the basic info access 420. At step 422, they use your request basic recorder information data from the server 111 web site at step 423, the basic until access 420 obtains the document from the server 11 web site.

Next, the basic info access 420 determines if the data is to be stored locally. If it is determined at step 424 that the data is not to be stored locally, the basic info access 420 exits at step 429. However, if it is determined at step 424 that the data is to be stored locally, then the data is stored locally at step 425. The basic edition access 420 exits at step 429.

FIG. 6A is a flow chart illustrating an example of the operation of the servicer edition process 240 on server 11 and utilized by the recorder information system 200 of the present invention, as shown in FIGS. 2A and 4A. The servicer edition process 240 enables the server 11 to calculate fees for a number of events. In the illustrated example, the servicer addition process 240 provides a Web-based application for calculating recording fees for the recordation of lien releases, assignments, substitutions, a trustee and other service documents, as while providing county requirements, contact information sample documents and state statutes.

First at step 241, the servicer edition process 240 is initialized. This initialization includes the startup routines and processes embedded in the BIOS of the server 11. The initialization also includes the establishment of data values for particular data structures utilized in the servicer edition process 240.

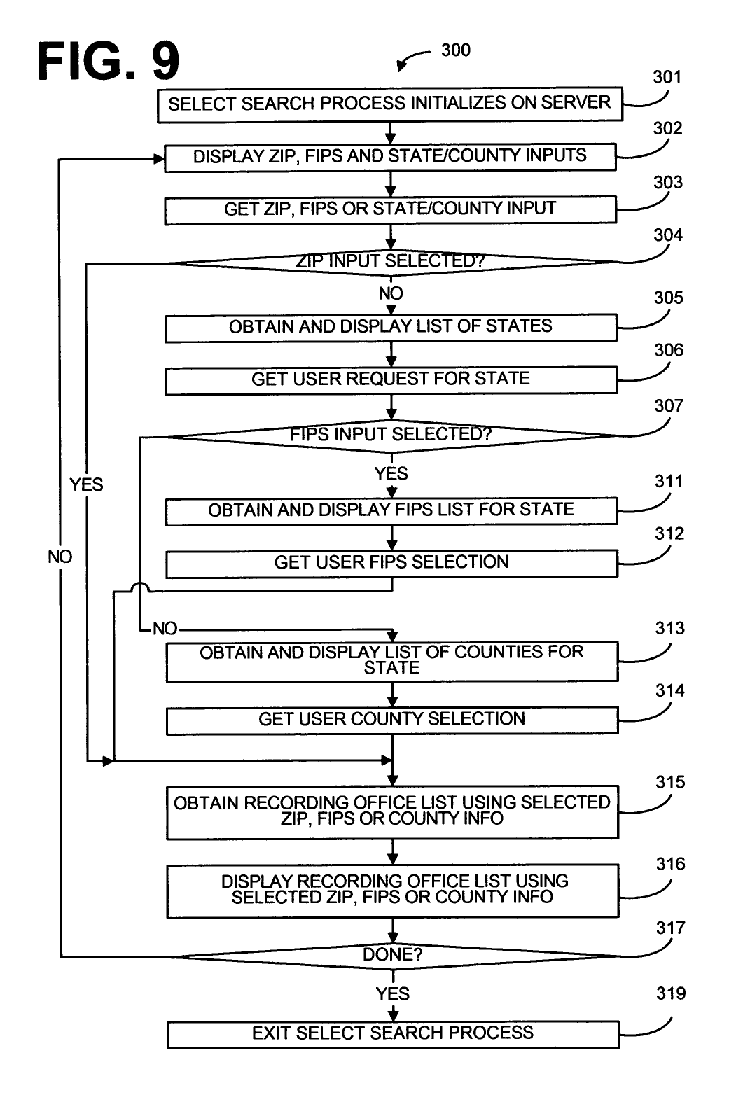

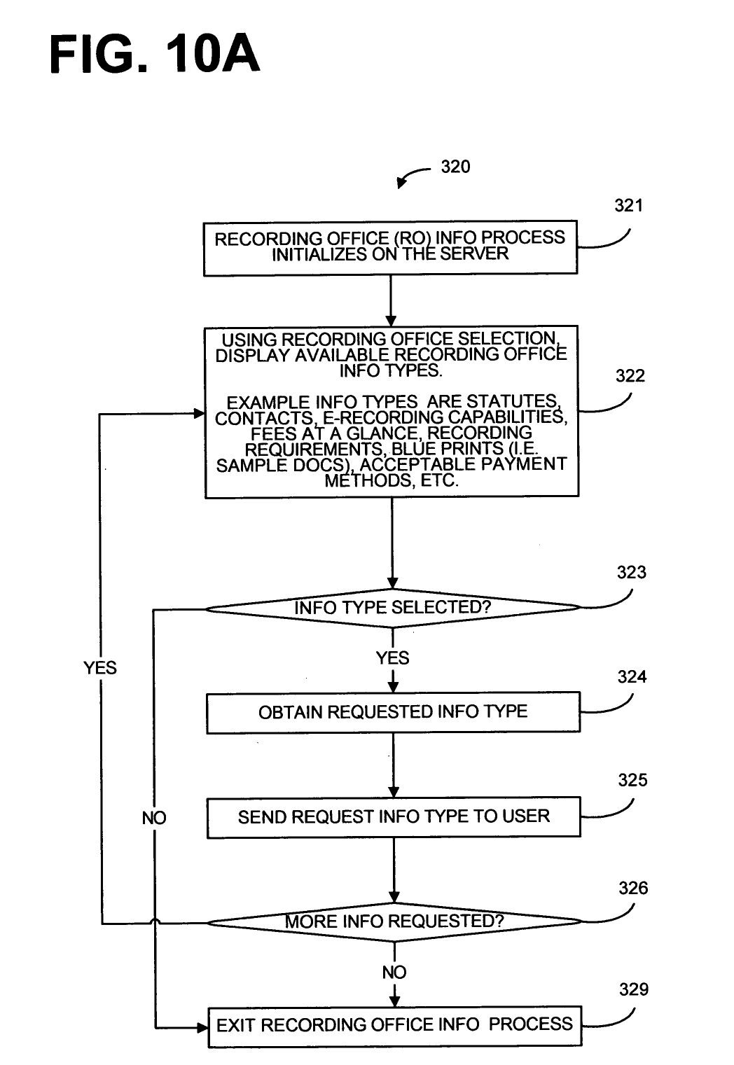

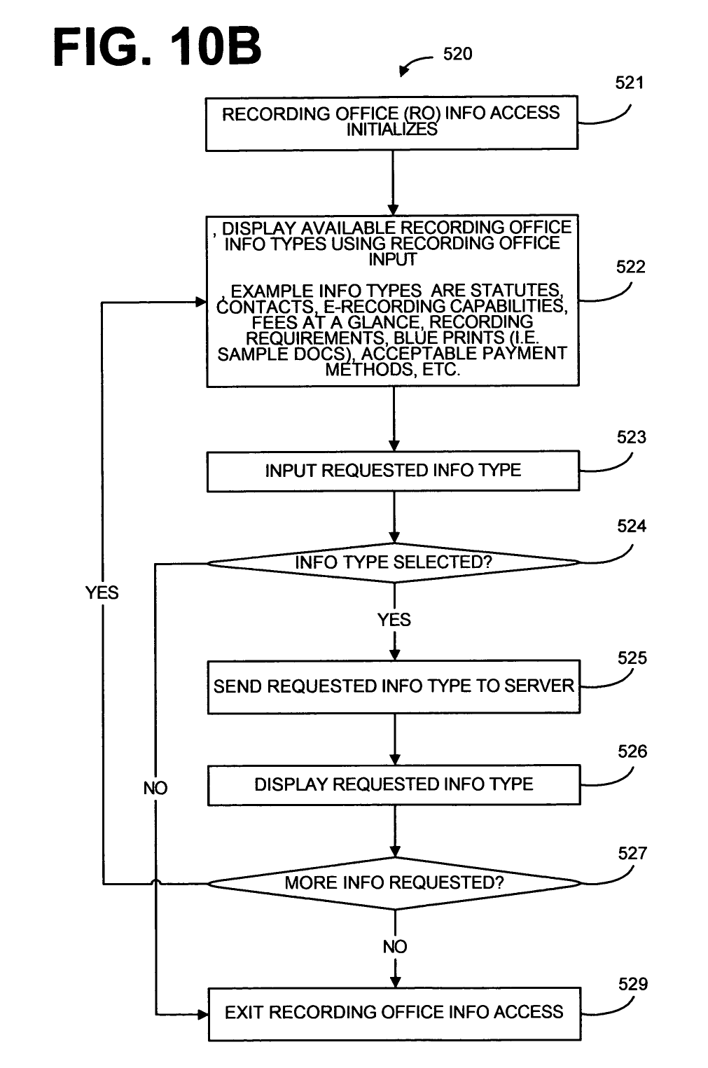

At step 242, the servicer edition process 240 executes the select search method. The select search is herein defined further detail with regard to FIG. 9. After performing select search method at step 242, the servicer addition process 240 initiates the selection of the recording office at step 243. At step 244, RIO info process is performed. The R/O info process is herein defined further detail with regard to FIG. 10.

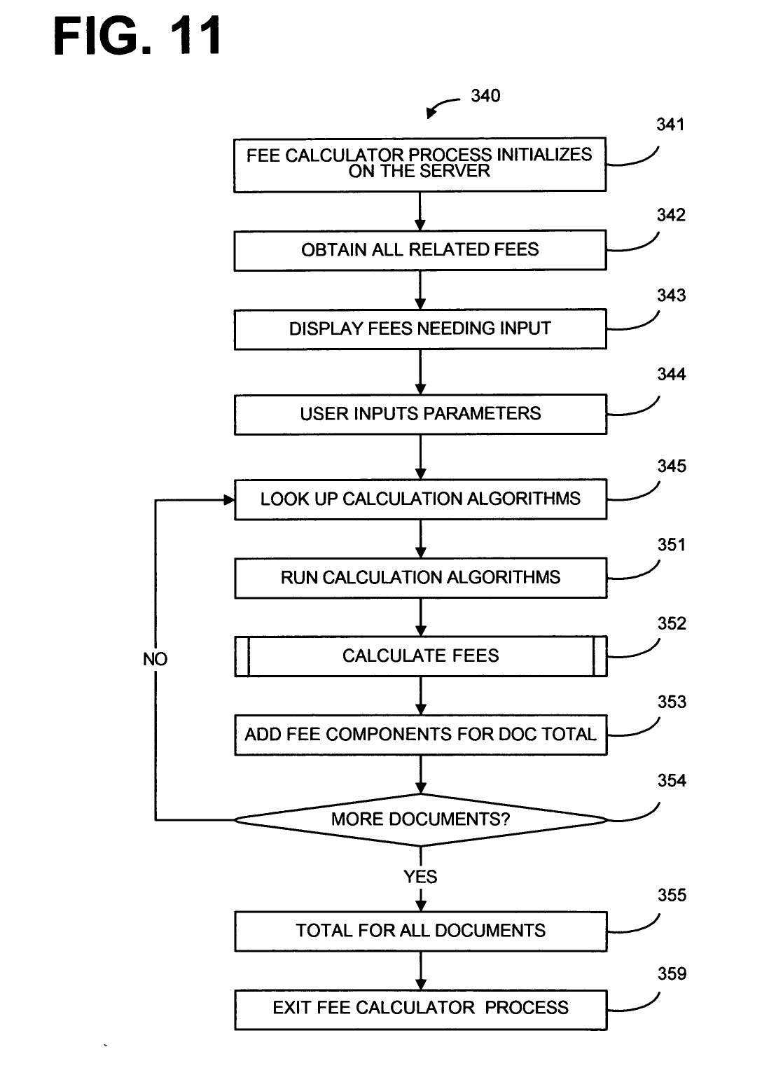

At step 245, the servicer addition process 240 obtained the recordable document list. At step 246, the recordable documents list is displayed to enable a user to select the desired documents. At step 247, the user selects the documents that are applicable. At step 248, the servicer addition process to 40 performed be calculator. The calculator as herein defined in further detail with regard to FIG. 11.

The contact information and the special instructions for the selected recording office are obtained at steps 251 and 252 respectively. The jurisdiction rules are obtained at step 253, and all the information is displayed at step 254. At step 255 the servicer addition process to 40 flags calculations with special instructions. At step 256, the servicer edition process 240 displays the page with the user parameters and calculation results and logs the transaction at step at 257.

At step 258, is determined if more processing is required. If it is determined at step 258 that more processing is required, the servicer addition process to 40 then returns to repeat steps 242 to 258. However, if it is determined that no further processing is required, then the servicer edition process 240 exits at step 259.

FIG. 6B is a flow chart illustrating an example of the operation of servicer access 440 utilized in the remote client devices 13 and with the recorder information system 200 of the present invention, as shown in FIGS. 2B and 4B. In the illustrated example, the servicer access 440 enables a user to acquire recording fees for the recordation of lien releases, assignments, substitutions of trustee and other service documents, as while providing county requirements, contact information sample documents and state statutes.

First at step 441, the servicer access 440 is initialized. This initialization includes the startup routines and processes embedded in the BIOS of the remote client devices 13. The initialization also includes the establishment of data values for particular data structures utilized in the servicer access 440. At step 222, 80 is a request a search method by entering the selected criteria information. This selected criteria information comprises of zip code, FIPS or state and county information. FIPS is a term derived from a 3 digit subset of the Federal Information Processing Standard (FIPS) assigned to represent the counties and other governmental entity. It is equivalent legal and/or statistical subdivisions of the 50 states and the District of Columbia and the possessions and really associated areas of the United States. Counties are considered to be first-order subdivisions of each state and statistically a the equivalent entity regardless of their local designations.

At step 443, the user requests the desired recording office. At step 444, the service access 440 performed the RIO info access. The RIO info access is herein defined in further detail with regard to FIG. 10B.

At step 440 by of the recordable documents list is obtained from server 11 and then displayed to the user at step 451. At step 452, the user selects the desired documents in the list. The selected documents are then displayed at step 453. At step 454, the servicer access 440 requests application of any special instructions for the selected documents. The data is then displayed with the user parameters and calculation results at step 455.

At step 456, the servicer access 440 determines if there is more processing to be done. If it is determined that there is more processing can be done, the servicer access 440 then returns to repeat steps 442 through 456. However, if it is determined that no further processing is needed, then the servicer access 440 exited at step 459.

FIG. 7A is a flow chart illustrating an example of the operation of the originator process 260 on server 11 and utilized by the recorder information system 200 of the present invention, as shown in FIGS. 2A and 4A. In the illustrated example, the originator access 260 enables the server 11 to calculate recording fees and government taxes due at closing. The calculations are based upon questions regarding specific property and transaction type. The result of provided to the user with recording fees needed to record the closing documents and take the guesswork out of transfer, intangible, invisible in the school district taxes that must be disclosed, collected and paid.

First at step 261, the originator process 260 is initialized. This initialization includes the startup routines and processes embedded in the BIOS of the server 11. The initialization also includes the establishment of data values for particular data structures utilized in the originator process 260. At step 262, the search method is performed. The select search method is herein described in further detail with regard to FIG. 9.

At step 262, the originator process 260 executes the select search method. The select search is herein defined further detail with regard to FIG. 9. After performing select search method at step 262, the originator process 260 initiates the selection of the recording office at step 263. At step 264, the originator process to 60 obtains a recordable document list and then displayed the list at step 265. At step 266, the user selects the documents that are applicable. At step 267, the user selects the applicable tax transaction types.

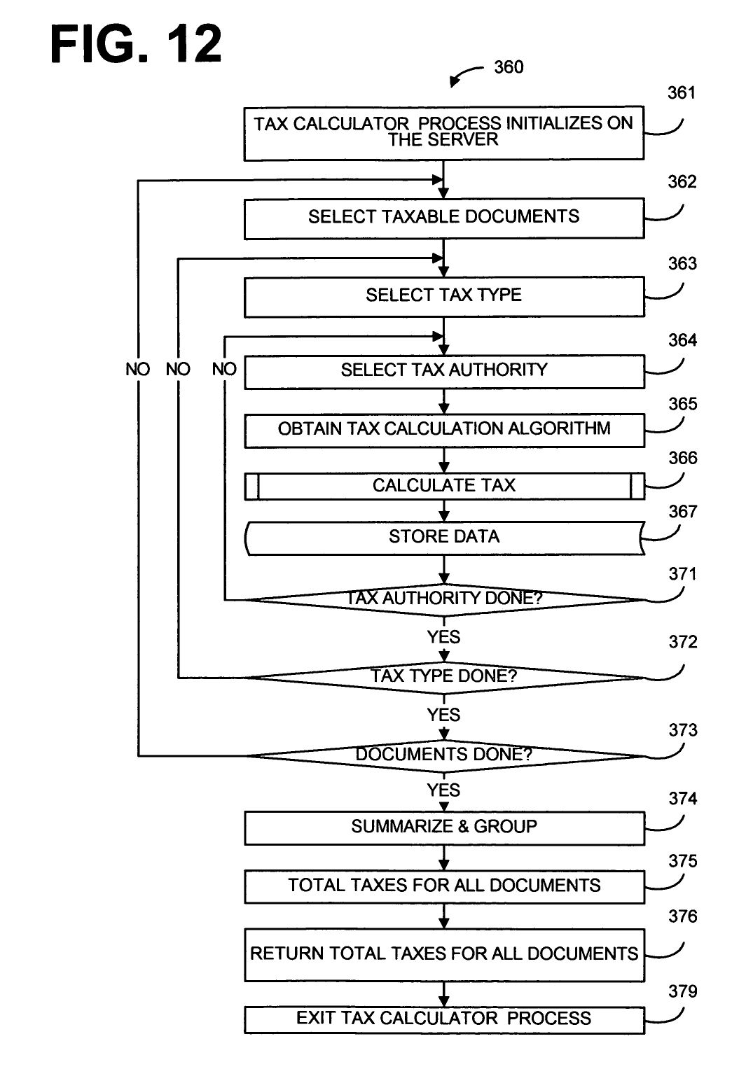

At step 268, the originator process 260 performs the fee calculator. The fee calculator as herein defined in further detail with regard to FIG. 11. At step 269, the originator process 260 performs the tax calculator. The tax calculator as herein defined in further detail with regard to FIG. 12.

The contact information and the special instructions for the selected recording office are obtained at steps 271 and 272 respectively. The jurisdiction rules are obtained at step 273, and all the information is displayed at step 274. At step 275 the originator process 260 flags calculations with special instructions. At step 276, the originator process 260 displays the page with the user parameters and calculation results and logs the transaction at step 277.

At step 278, is determined if more processing is required. If it is determined at step 278 that more processing is required, the originator process 260 then returns to repeat steps 242 through 258. However, if it is determined that no further processing is required, then the originator process 260 exits at step 279.

FIG. 7B is a flow chart illustrating an example of the operation of the originator access 460 utilized in the remote client devices 13 and utilized by the recorder information system 200 of the present invention, as shown in FIGS. 2B and 4B. The originator access 460 enables the remote client devices 13 to download additional software or software changes.

First at step 461, the originator access 460 is initialized. This initialization includes the startup routines and processes embedded in the BIOS of the remote client devices 13. The initialization also includes the establishment of data values for particular data structures utilized in the originator access 460.

First at step 461, the originator access 460 is initialized. This initialization includes the startup routines and processes embedded in the BIOS of the remote client devices 13. The initialization also includes the establishment of data values for particular data structures utilized in the originator access 460. At step 462, the user requests a search method by entering the selected criteria information. This selected criteria information comprises of zip code or state/county information. At step 463, the user requests the desired recording office.

At step 464, the recordable documents list is obtained from server 11 and then displayed to the user at step 465. At step 471, the user selects the desired documents in the list. The selected documents are then displayed at step 472. At step 473, the originator access 460 requests application of any special instructions for the selected documents. The data is then displayed with the user parameters and calculation results at step 474.

At step 475, the originator access 460 determines if there is more processing to be done. If it is determined that there is more processing can be done, the originator access 460 then returns to repeat steps 462 through 475. However, if it is determined that no further processing is needed, then the originator access 460 exited at step 479.

FIG. 8A is a flow chart illustrating an example of the operation of the fee wise process 280 on server 11 and utilized by the recorder information system 200 of the present invention, as shown in FIGS. 2A and 4A. In the illustrated example, the fee wise process 280 provides an XML data stream solution that can be in other applications. The fee wise process 280 provides originator process 260 information with the decision engine in the flexibility of XML delivery. When used in document creation applications, the fee wise process 280 provide users with a tool to produce accurate recording fees and government tax results for good-faith estimates, HUD 1 settlement statements, payoff statements, checks and the like.

First at step 281, the fee wise process 280 is initialized. This initialization includes the startup routines and processes embedded in the BIOS of the server 11. The initialization also includes the establishment of data values for particular data structures utilized in the fee wise process 280. At step 282, the fee wise process 280 receives a request for a transaction ID. At step 283, the request for transaction ID is validated and then a valid transaction ID is returned.

At step 284, the fee wise process 280 receives a request for the recording offices and the state/zip code parameters. At 285, the fee wise process 280 obtains the list of recording offices and then sends them to the user. At step 286, the fee wise process 280 receives a request for loan types, and recording office ID parameters. At step 287, the fee wise process 280 obtains the list of a loan types and send them to the user.

At step 291, a request for documents passed recording office ID parameters is received. At step 292, the fee wise process 280 obtains a list of documents and sends them to the user. At step 293, a request from the calculations with collected parameters is received. At step 294, the fee wise process 280 performs the fee calculation and the tax calculation processes using the input parameters. The fee calculation processes herein defined in further detail with regard to FIG. 11 and the tax speculation process is herein defined in further detail with regard FIG. 12.

After performing the fee and tax calculation at step 294, the fee wise process 280 returned to XML calculation result to the user at step 295. At step 296, the fee wise process 280 determines if there is more processing to be performed. If it is determined at step 296 that there is more processing to be performed, then the fee wise process returns to repeat steps 282 through 296. However, if it is determined at step 296 that there is no more processing to be performed, then the fee wise process 280 then exit the step 299.

FIG. 8B is a flow chart illustrating an example of the operation of the fee wise access 480 utilized in the remote client devices 13 and utilized by the recorder information system 200 of the present invention, as shown in FIGS. 2B and 4B. The fee wise access 480 provides originator process 260 information with the decision engine with the flexibility of XML delivery. When used in document creation applications, the fee wise process 280 provide users with a tool to produce accurate recording fees and government tax results for good-faith estimates, HUD1 settlement statements, payoff statements, checks and the like.

First at step 481, the fee wise access 480 is initialized. This initialization includes the startup routines and processes embedded in the BIOS of the remote client devices 13. The initialization also includes the establishment of data values for particular data structures utilized in the fee wise access 480. At step 482, the fee wise access 480 enables users to input authentication information. This authentication information is sent to the server 11 all along with a request for a transaction ID at step 483. At step 484, the fee wise access 480 wait to receive the transaction ID.

After receiving a transaction ID at step 484, the fee wise access 480 then request recording office information, along with state and zip code parameters at steps 485 and 486, respectively. At step 487, the fee wise access 480 waits to receive a list of recording office that was requested at step 486.

After receiving a list of recording office is at step 487, the user then is able to request transaction types at step 488 and pass recording office ID parameters to the server requesting a list of tax transaction types at step 489. At step 490, the fee wise access 480 waits to receive the list of tax transition types. After receiving the list of tax transaction types, the fee wise access 480 request document the step 491 and passes the recording office ID parameters to the server at step 492. At step 493, the fee wise access 480 waits to receive the list of documents and fee parameters.

After receiving the list of documents and fee parameters at step 493, the fee wise access 480 request that the fee and tax of calculations at step 494 and passes the collected parameters at step 495 to server 11. At step 496 the fee wise access process 480 waits to receive the XML calculation results.

After receipt the XML calculation result, the fee wise access 480 save the resulting data step 497. At step 498, the wise access 480 determines if more processing is to be performed. If it is determined that more processing is to be performed, and the fee access 480 returns to repeat steps 482 through 498. However, if it is determined at step 498 that there is no more processing to be performed, then the fee wise access, 480 exit the step 499.

FIG. 9 is a flow chart illustrating an example of the operation of the select search process 300 utilized by the recorder information system 200 of the present invention, as shown FIGS. 2A, 6A and 7A. The select search process 300 provides for the ability of the user to search for at the appropriate recording office utilizing either zip code, FIPS or state and county data.

First at step 301, the search process 300 is initialized. This initialization includes the startup routines and processes embedded in the BIOS of the server 11. The initialization also includes the establishment of data values for particular data structures utilized in the search process 300. At step 302, the select search process 300 displays a zip code, FIPS and state/county inputs. At step 303, input of the user is obtained. At step 304, it is determined in the zip code was input was selected. If it is determined that the zip code was selected, then fee select search process 300 perceived to step 315. However, if it is determined at step 304 that the zip input was not selected, then the select search process 300 obtains and displays a list of all states at step 305.

At step 307, it is determined if the FIPS input was selected. If it is determined at step 307 that the FIPS input was not selected, then the select search process 300 proceeds to step 313. However, if it is determined at step 307 that the FIPS input was selected, then the select search process 300 obtains and displays a FIPS list for the state selected at step 311. At step 312, the select search process 300 then obtained the users FIPS input and proceeds to step 315.

At step 313, a list of counties is obtained and displayed for the state selected at step 306. The users county selection is then obtained at step 314.

At step 315, the recording office list using the selected zip code, FIPS or county information is obtained. The recording office list is then displayed at step 316. At step 317, these the select search process 300 determined that there is more searching can be performed. If it is determined at step 317 that there is more searching to be performed, then the select search process 300 returns to repeat steps 302 through 317. However, that is determined that no more searching is to be performed, then the select search process 300 exits at step 319.

FIG. 10A is a flow chart illustrating an example of the operation of the recording office info process 320 utilized by the recorder information system 200 of the present invention, as shown in FIGS. 2A, 6A and 7A. The recording office info process 320 enables a user to display available recording office info types.

First at step 321, the recording office info process 320 is initialized. This initialization includes the startup routines and processes embedded in the BIOS of the server 11. The initialization also includes the establishment of data values for particular data structures utilized in the recording office info process 320. At step 322, the available recording office info types is displayed to a user. These information types include but are not limited to statutes, contacts, e-recording capabilities, fees at a glance, recording requirements, blueprints (i.e. simple documents), acceptable payment methods and the like.

At step 323, the recording office info process 320 determines if a information type was selected. If it is determined that an information type was not selected, then the recording office info process 320 exits at step 329. However, if it is determined at step 323 that an information type was selected, then at step 32 for the recording office info process 320 obtains the requested information type. At step 325, the requested information type is sent to the user.

At step 326, it is determined if more information is to be requested. If it is determined to step 326 that there is more information to be requested, then the recording office info process 320 returns to repeat steps 322 through 326. However, if it is determined, no more information is to be requested, then the recording office info process 320 exits at step 329.

FIG. 10B is a flow chart illustrating an example of the operation of the recording office info access utilized in the remote client device and utilized by the remote recorder system 400 of the present invention, as shown in FIGS. 2B, 6B and 7B. The recording office info access 520 enables a user to display available recording office info types.

First at step 521, the recording office info access 520 is initialized. This initialization includes the startup routines and processes embedded in the BIOS of the server 11. The initialization also includes the establishment of data values for particular data structures utilized in the recording office info access 520. At step 522, the available recording office info types is displayed to a user. These information types include but are not limited to statutes, contacts, E-recording capabilities, these the glance, recording requirements, blueprints (i.e. simple documents), acceptable payment methods and the like.

At step 523, the recording office info access 520 accepts a information type request. If it is determined that an information type was not requested, then the recording office info access 520 exits at step 529. However, if it is determined at step 523 that an information type was selected, then at step 524 the recording office info access 520 sends the requested information type to server 11. At step 525, the requested information type is sent to the user. At step 526, the recording office info access 520 displays the requested information received from server 11.

At step 527, it is determined if more information is to be requested. If it is determined to step 527 that there is more information to be requested, then the recording office info access 520 returns to repeat steps 522 through 527. However, if it is determined, no more information is to be requested, then the recording office info access 520 exits at step 529.

FIG. 11 is a flow chart illustrating an example of the operation of the fee calculator process 340 utilized by the recorder information system 200 of the present invention, as shown in FIGS. 2A and 4A. The fee calculator process determines which fee calculation algorithms are to be utilized in the calculation from input parameters. After providing the calculation process thing can total the fees of all these charged and provide an itemized list of fees and the total.

First at step 341, the fee calculator process 340 is initialized. This initialization includes the startup routines and processes embedded in the BIOS of the server 11. The initialization also includes the establishment of data values for particular data structures utilized in the fee calculator process 340. At step 342, the fee calculator process 340 obtains all related fees and displays them at step 343. At step 344 the user input any parameters needing further definition.

At step 345, the fee calculator process 340 performs a lookup of calculation algorithms. These calculation algorithms are then executed at step 351 and the fees are calculated at step 352. At step 353, the fee components are added together for a document total. At step 354, it current transaction. It is determined, there are more documents to be process, then the fee calculator process 340 then returns to repeat step 345 through 354. However, if it is determined that step 354 that there are no more additional documents to be process, the fee calculator process 340 totals the fees for all documents at step 355, returns that total and exits at step 359.

FIG. 12 is a flow chart illustrating an example of the operation of the tax calculator process 360 utilized by the recorder information system 200 of the present invention, as shown in FIGS. 2A and 4A.

First at step 361, the tax calculator process 360 is initialized. This initialization includes the startup routines and processes embedded in the BIOS of the server 11. The initialization also includes the establishment of data values for particular data structures utilized in the tax calculator process 360. At step 362, the taxable documents are selected. At step 363, the tax calculator process 360 select the tax type, and then the tax authority at step 364. At that 365, the tax calculator process 360 obtain the tax calculation algorithms applicable. At step 366, the tax are computed and that tax data stored at step 367.

At step 371, the tax cut delete a process 360 determined if there are more transactions for that tax authority. If it is determined that there are more computations for the tax authority, then the tax calculator process 360 returns to repeat steps 364 through 371. However it is determined that there are no more computations for the current tax authority, then the tax calculator process 360 determines if there are additional tax type calculations to be performed at step 372. If it is determined that additional tax type calculations are to be performed, then the tax calculator process 360 returns to repeat steps 363 through 372.

However, if it is determined that additional tax type calculations are not to be performed, then the tax calculator process 360 determines that there are more documents for taxes to be computed at step 373. If it is determined that more documents are to be processed, that tax calculator process 360 then returns to repeat steps 362 through 373.

However, if it is determined that there are no more documents for tax calculations to be performed, and the tax calculator process 36 be summarized as an group the tax calculations at step 374. The total taxes for all documents are computed at step 375 and then the total taxes for all documents are returned at step 376. At step 379, the tax calculator process exits.

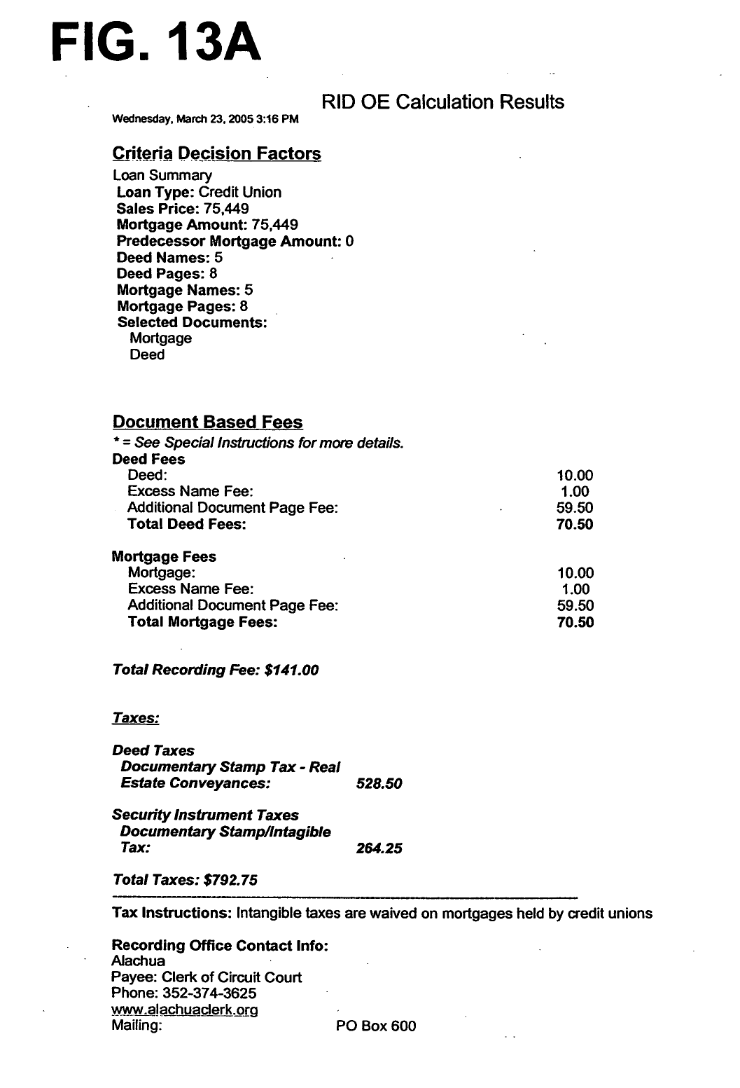

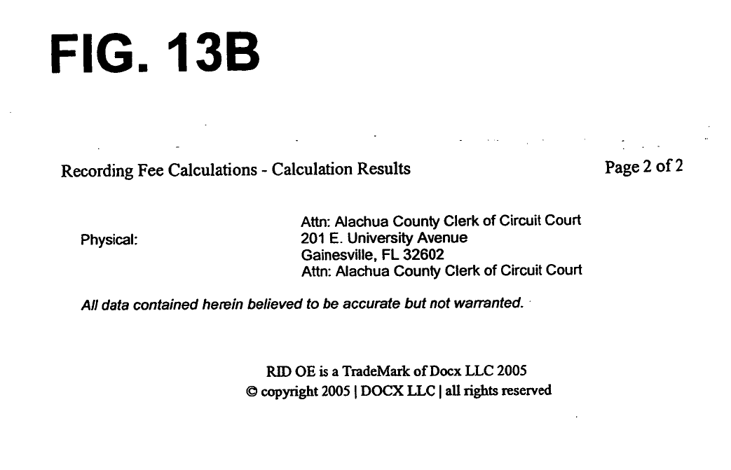

FIGS. 13A-B are screen prints illustrating an example of the output of the recorder information system of the present invention, as shown in 2A, 6A, and 7A.

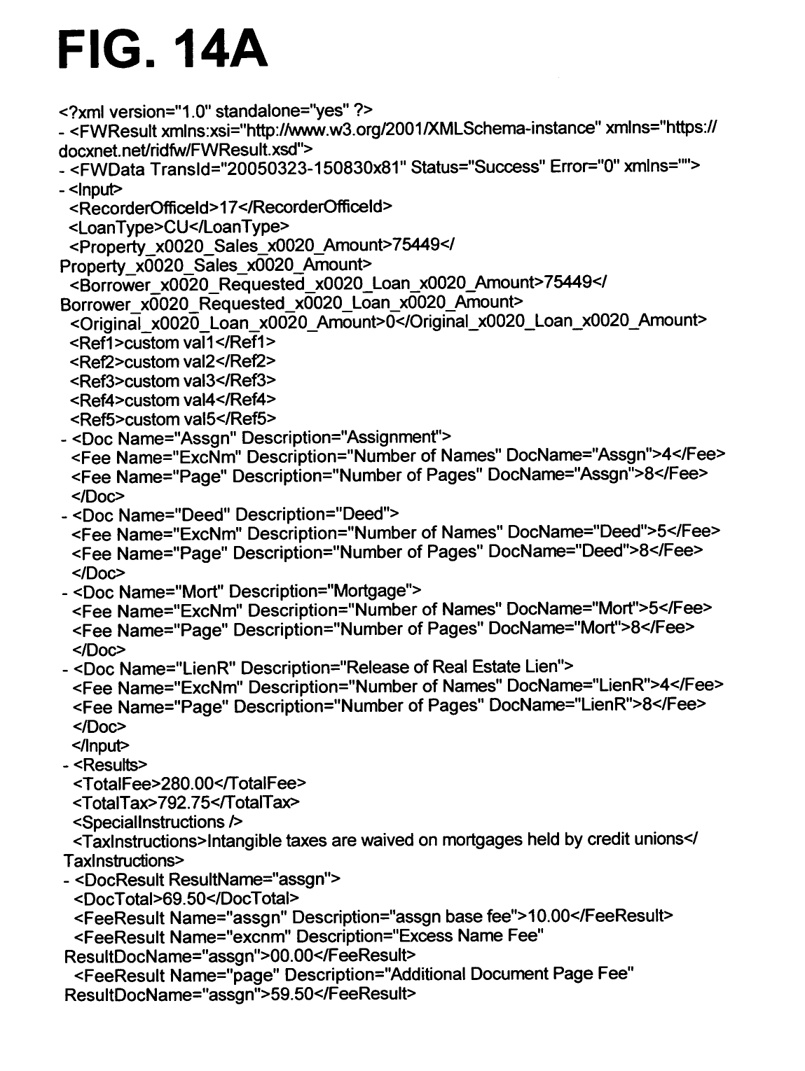

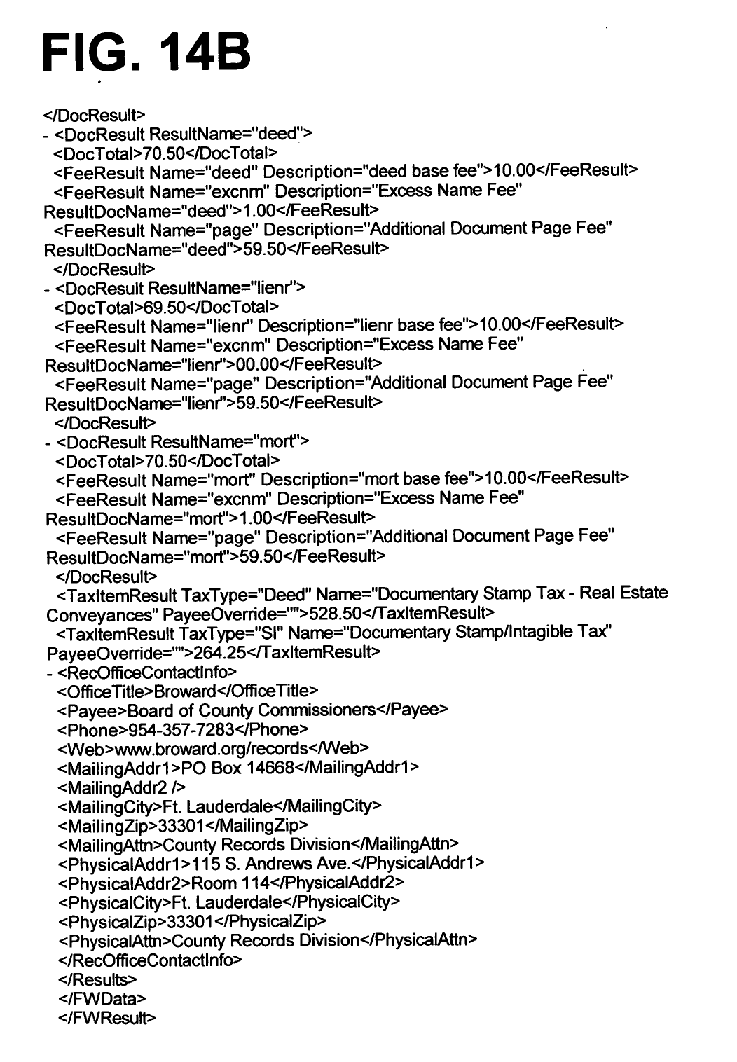

FIGS. 14A-B are a data stream illustrating an example of the XML output of the recorder information system of the present invention, as shown in 2A and 8A.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

1. A method for calculating applicable recording charges for a transaction, the method comprising:
determining which recording office is appropriate for recording the transaction;
determining a type of the transaction;
calculating at least one charge required for recording the transaction; and
displaying total charges for recording the transaction.

2. The method of claim 1, further comprising the step of:
determining a plurality document types for the transaction, and
displaying all charges needed for each of the at least one document type for recording the transaction.

3. The method of claim 2, wherein the calculating at least one charge step further comprising the step of:
determining if a tax payment is needed when completing the transaction.

4. The method of claim 3, wherein the calculating at least one charge step further comprising the step of:
determining at least one tax authority for any needed tax payment.

5. The method of claim 4, wherein the calculating at least one charge step further comprising the step of:
determining at least one tax type for any needed tax payment.

6. The method of claim 5, wherein the calculating at least one charge step further comprising the step of:
determining at least one tax algorithm for any needed tax payment.

7. The method of claim 6, wherein the calculating at least one charge step further comprising the step of:
calculating at least one applicable tax needed for completing the transaction using the tax algorithm.

8. The method of claim 2, wherein the calculating at least one charge step further comprising the step of:
determining at least one fee type for the charge.

9. The method of claim 8, wherein the calculating at least one charge step further comprising the step of:
determining at least one fee algorithm for the charge.

10. The method of claim 9, wherein the calculating at least one charge step further comprising the step of:
calculating any applicable fee needed for recording the transaction using the fee algorithm.

11. A method for calculating applicable recording charges for a refinance transaction, the method comprising:
determining if the refinance transaction amount is greater than the original amount of the existing mortgage; and
calculating a tax amount for the refinance transaction based upon a difference between the original amount of the existing mortgage and the greater refinance transaction amount if the refinance lender is the same as the originating lender for the existing mortgage.

12. The method of claim 11, further comprising the step of:
calculating a difference between the refinance transaction and the original amount of the existing mortgage.

13. A method for calculating applicable recording charges for a transaction, the method comprising:
determining if a credit union is a lender for the transaction; and
calculating a tax amount for the transaction excluding any intangible tax from the tax amount due when the lender is a non-credit union.

14. A method for calculating applicable recording charges for a transaction, the method comprising:
calculating any deed recording charges for a deed document;
calculating any mortgage recording charges for a mortgage document;
calculating total charges including the deed recording charges, and the mortgage recording charges; and
providing the total charges to a remote client device.

15. The system of claim 14, further comprising:
providing itemized listing of the mortgage recording charges and deed recording charges to the remote client device.

16. A method for calculating applicable recording charges for a transaction, the method comprising:
determining if the transaction includes at least one secondary document;
calculating secondary document recording charges; and
providing the secondary document recording charges to a remote client device.

17. The method of claim 16, wherein the secondary document is selected from the group consisting of assignments, cancellation of mortgage, deed of trust, power of attorney, release of real estate lien, satisfaction of mortgage, substitution of trustee, substitution of trustee-deed of reconveyance.

18. A method for calculating applicable recording charges for a document, the method comprising:
determining which recording office is appropriate for recording the document;
determining a document type for the document;
determine if the document is non-compliant for the document type as defined by rules of the recording office, and calculating a noncompliant charge required for recording the document; and
displaying noncompliant charge for recording the document.

19. A method for calculating applicable recording charges for a document, the method comprising:
determining which recording office is appropriate for recording the document;
determining a document type for the document;
determine if a number of names on the document exceeds a threshold defined by the recording office for the document type as defined by rules of the recording office, and calculating excess name charge required for recording the document; and
displaying the excess name charge for recording the document.

20. A method for calculating applicable recording charges for a document, the method comprising:
determining which recording office is appropriate for recording the document;
determining a document type for the document;
determine if a number of parcels on the document exceeds one parcel, and calculating excess parcel charge required for recording the document; and
displaying the excess parcel charge for recording the document.

21. A method for calculating applicable recording charges for a document, the method comprising:
determining if the document was delivered in acceptable electronic format as defined by an applicable recording office;
calculating a electronic delivery charge amount for the document;
providing the electronic delivery charge amount to a remote client device.

22. A system that calculates applicable recording charges for a transaction, comprising:
means for determining which recording office is appropriate for recording the transaction;
means for determining a type of the transaction;
means for calculating at least one charge required for recording the transaction; and
means for displaying total charges for recording the transaction.

23. The system of claim 22, further comprising:
means for determining a plurality document types for the transaction, and
means for displaying all charges needed for each of the at least one document type for recording the transaction.

24. The system of claim 23, further comprising:
means for determining if a tax payment is needed when completing the transaction.

25. The system of claim 24, further comprising:
means for determining at least one tax authority for any needed tax payment

26. The system of claim 25, further comprising:
means for determining at least one tax type for any needed tax payment.

27. The system of claim 26, further comprising:
means for determining at least one tax algorithm for any needed tax payment.

28. The system of claim 27, further comprising:
means for calculating at least one applicable tax needed for completing the transaction using the tax algorithm.

29. The system of claim 23, further comprising:
means for determining at least one fee type for the charge.

30. The system of claim 29, further comprising:
means for determining at least one fee algorithm for the charge.

31. The system of claim 30, further comprising:
means for calculating any applicable fee needed for recording the transaction using the fee algorithm.

32. A system that calculates applicable recording charges for a transaction, comprising:
logic for determining which recording office is appropriate for recording the transaction;
logic for determining a type of the transaction;
logic for calculating at least one charge required for recording the transaction; and
logic for displaying total charges for recording the transaction.

33. The system of claim 36, further comprising:
logic for determining a plurality document types for the transaction, and
logic for displaying all charges needed for each of the at least one document type for recording the transaction.

34. The system of claim 33, further comprising:
logic for determining if a tax payment is needed when completing the transaction.

35. The system of claim 34, further comprising:
logic for determining at least one tax authority for any needed tax payment

36. The system of claim 35, further comprising:
logic for determining at least one tax type for any needed tax payment.

37. The system of claim 36, further comprising:
logic for determining at least one tax algorithm for any needed tax payment.

38. The system of claim 37, further comprising:
logic for calculating at least one applicable tax needed for completing the transaction using the tax algorithm.

39. The system of claim 33, further comprising:
logic for determining at least one fee type for the charge.

40. The system of claim 39, further comprising:
logic for determining at least one fee algorithm for the charge.

41. The system of claim 40, further comprising:
logic for calculating any applicable fee needed for recording the transaction using the fee algorithm.

42. A method for calculating applicable recording charges for a transaction recorded in the state of Illinois, the method comprising:
determining if a city tax is due for a taxing authority in Illinois, other than Chicago;
calculating the city tax for the taxing authority in Illinois other than Chicago; and
providing the city deed tax to a remote client device.

43. A method for calculating applicable recording charges for a transaction recorded in the state of Vermont, the method comprising:
determining if the sales price of the transaction being recorded is greater than a predetermined amount and determining any excess amount over the predetermined amount;
calculating a tax amount as a first tax rate multiplied by the predetermined amount plus, the excess amount multiplied by a second tax rate if the sales price exceeds the predetermined amount; and
calculating the tax amount as the first tax rate multiplied the sales price if the sales price is less than or equal to be predetermined amount; and
providing the tax amount to a remote client device.

44. A system that calculates applicable recording charges for a refinance transaction, comprising:
means for determining if the refinance transaction amount is greater than the original amount of the existing mortgage; and
means for calculating a tax amount for the refinance transaction based upon a difference between the original amount of the existing mortgage and the greater refinance transaction amount if the refinance lender is the same as the originating lender for the existing mortgage.

45. The system of claim 44, further comprising:
means for calculating a difference between the refinance transaction and the original amount of the existing mortgage.

46. A system that calculates applicable recording charges for a transaction, comprising:
means for determining if a credit union is a lender for the transaction; and
means for calculating a tax amount for the transaction excluding any intangible tax from the tax amount due when the lender is a non-credit union.

47. A system that calculates applicable recording charges for a transaction, the method comprising:
means for calculating any deed recording charges for a deed document;
means for calculating any mortgage recording charges for a mortgage document;
means for calculating total charges including the deed recording charges, and the mortgage recording charges; and
means for providing the total charges to a remote client device.

48. The system of claim 47, further comprising:
means for providing itemized listing of the mortgage recording charges and deed recording charges to the remote client device.

49. A system that calculates applicable recording charges for a transaction, the method comprising:
means for determining if the transaction includes at least one secondary document;
means for calculating secondary document recording charges; and
means for providing the secondary document recording charges to a remote client device.

50. The system of claim 49, wherein the secondary document is selected from the group consisting of assignments, cancellation of mortgage, deed of trust, power of attorney, release of real estate lien, satisfaction of mortgage, substitution of trustee, substitution of trustee-deed of reconveyance.

51. A system that calculates applicable recording charges for a document, the method comprising:
means for determining which recording office is appropriate for recording the document;
means for determining a document type for the document;
means for determine if the document is non-compliant for the document type as defined by rules of the recording office, and calculating a noncompliant charge required for recording the document; and
means for displaying noncompliant charge for recording the document.

52. A system that calculates applicable recording charges for a document, the method comprising:
means for determining which recording office is appropriate for recording the document;
means for determining a document type for the document;
means for determine if a number of names on the document exceeds a threshold defined by the recording office for the document type as defined by rules of the recording office, and calculating excess name charge required for recording the document; and
means for transmitting the excess name charge for recording the document.

53. A system that calculates applicable recording charges for a document, the method comprising:
means for determining which recording office is appropriate for recording the document;
means for determining a document type for the document;
means for determine if a number of parcels on the document exceeds one parcel, and calculating excess parcel charge required for recording the document; and
means for displaying the excess parcel charge for recording the document.

54. A system that calculates recording charges for a document, the method comprising:
means for determining if the document was delivered in acceptable electronic format as defined by an applicable recording office;
means for calculating a electronic delivery charge amount for the document;
means for providing the electronic delivery charge amount to a remote client device.

55. A system that calculates applicable recording charges for a transaction recorded in the state of Illinois, the method comprising:
determining if a city tax is due for a taxing authority in Illinois, other than Chicago;
calculating the city tax for the taxing authority in Illinois other than Chicago; and
providing the city deed tax to a remote client device.

56. A system that calculates applicable recording charges for a transaction recorded in the state of Vermont, the method comprising:
determining if the sales price of the transaction being recorded is greater than a predetermined amount and determining any excess amount over the predetermined amount;
calculating a tax amount as a first tax rate multiplied by the predetermined amount plus, the excess amount multiplied by a second tax rate if the sales price exceeds the predetermined amount; and
calculating the tax amount as the first tax rate multiplied the sales price if the sales price is less than or equal to be predetermined amount; and
providing the tax amount to a remote client device.
